(19) United States
(12) Patent Application Publication
(10) Pub. No.: US 2026/0075363 A1
(43) Pub. Date: Mar. 12, 2026

(54) Ambisonic Microphone

(71) Applicant: Shure Acquisition Holdings, Inc., Niles, IL (US)

(72) Inventors: Brent Robert Shumard, Mount Prospect, IL (US); William Wallace Taylor, III, Gurnee, IL (US); Joseph Michael Bradel, South Beloit, IL (US)

(21) Appl. No.: 19/319,026

(22) Filed: Sep. 4, 2025

Related U.S. Application Data
(60) Provisional application No. 63/693,457, filed on Sep. 11, 2024.

(51) Int. Cl. H04R 5/027; H04R 1/08; H04R 3/00; H04R 5/04; H04S 3/00

(52) U.S. Cl. CPC H04R 5/027; H04R 1/08; H04R 3/005; H04R 5/04; H04S 3/008; H04R 2201/401; H04R 2430/20; H04S 2400/15; H04S 2420/11

(57) ABSTRACT

Methods and apparatuses for capturing and encoding ambisonic audio are described herein. An example ambisonic microphone may comprise multiple sets of microphone capsules arrayed around a central axis. Each set may include two microphone capsules positioned along a first axis that is perpendicular to the central axis and two microphone capsules positioned along a second axis that is perpendicular to the central axis and spaced apart from the first axis by a predetermined distance. The multiple sets may be arranged in a sequence such that each set of the multiple sets is rotated about the central axis in the same angular direction by a predetermined angle between adjacent sets in the sequence.

### CROSS-REFERENCE TO RELATED APPLICATION

This application claims priority to U.S. Patent Application No. 63/693,457, filed Sep. 11, 2024, which is hereby incorporated by reference in its entirety, and this application incorporates by reference in their entireties U.S. patent application Ser. No. 18/644,251, filed Apr. 24, 2024, and U.S. Provisional Patent Application No. 63/576,446, filed Apr. 28, 2023.

### FIELD

Aspects described herein generally relate to an ambisonic microphone, and/or hardware and/or software related thereto. More specifically, one or more aspects described herein provide for an array of microphone capsules for capturing ambisonic audio.

### BACKGROUND

Ambisonic audio may refer to a form of full-sphere periphony that may be used in many virtual reality and/or other immersive applications. Ambisonic audio may be encoded according to Ambisonics B-Format, where four A-format signals from four microphone capsules of an ambisonic microphone are encoded into four separate channels labeled W, X, Y, and Z. The W channel corresponds to the mono output from an omnidirectional microphone while the X, Y, and Z channels correspond to directional components of the sound signal. With the rising popularity of various services and applications utilizing ambisonic audio, there is an increasing demand for improvements in ambisonic microphones that can be achieved with relatively simple processes and with relatively low-cost equipment.

### SUMMARY

The following presents a simplified summary of the disclosure in order to provide a basic understanding of some aspects of the disclosure. This summary is not an extensive overview of the disclosure. It is not intended to identify key or critical elements of the invention or to delineate the scope of the invention. The following summary merely presents some concepts of the disclosure in a simplified form as a prelude to the more detailed description provided below.

Capturing ambisonic audio often requires extensive capital, cabling, external companion equipment, and advanced knowledge of A-format to B-format conversion techniques to attain a high-quality ambisonic audio signal. Additionally, the increasing accessibility and portability of equipment, such as used for podcasting, live streaming, and/or other recording, may allow a user to perform in various acoustic environments. However, depending on the application, a user might not have sufficient time, knowledge, and/or equipment to properly capture ambisonic audio to attain a desired audio quality.

As described in more detail herein, this application sets forth apparatuses, and methods for capturing ambisonic audio with an array architecture of microphone capsules with stable high frequency consistency, reduced phase error, and reduced acoustic shading. These apparatuses, and methods may be helpful in enabling a consumer to quickly and easily capture high-quality ambisonic audio, convert the ambisonic audio to a desired format, and/or utilize the ambisonic audio in one or more of a number of applications, such as immersive musical recordings, surround sound encoding, podcasting, video game audio design, stereoscopically tracked virtual reality/augmented reality experiences, and multichannel mixing, and/or one or more other applications.

An example ambisonic microphone may comprise a plurality of microphone capsules geometrically arranged to reduce an acoustic shading effect from a structural interference and compactly nested to reduce a phase-related error. The ambisonic may comprise a central axis, and first, second, third, and fourth pairs of microphone capsules. Each of the pairs may include an alignment axis perpendicular to the central axis and first and second microphone capsules. Each capsule may have a sensitivity pattern with maximum sensitivity vector that points in a direction that the capsule is most sensitive to sensing an audio signal. The first and second maximum sensitivity vectors for the first and second microphone capsules, respectively, may be perpendicular to the alignment axis and offset in opposite directions from the central axis by a first distance. The alignment axes of the first and the second pairs may be spaced apart from each other along the central axis by a second distance, and the alignment axes of the third and the fourth pairs may also be spaced apart along the central axis by the second distance.

In each of the pairs, the first and the second maximum sensitivity vectors may be pivoted about the alignment axis at a common angle and in opposite directions with respect to a plane formed by the alignment axis and the central axis. For example, the common angle of the first pair and the common angle of the third pair may be equal to a first value, and the common angle of the second pair and the common angle of the fourth pair may be offset 180 degrees from the first value. The first value may be between 30 and 60 degrees, which may orient the capsules in the first and the third pairs in the upward direction and the second and the fourth pairs in the downward direction.

In various examples, the alignment axis for each of the pairs may be rotated about the central axis at different angles. In one example, the alignment axes of the first and the third pairs may be in a first plane perpendicular to the central axis and may be perpendicular to each other. Likewise, the alignment axes of the second and the fourth pairs may be in a second plane perpendicular to the central axis and may be perpendicular to each other.

In other examples, the alignment axis of the first, the third, the second, and the fourth pairs may each be in a different plane perpendicular to the central axis and sequentially spaced along the central axis. The alignment axes of the third, the second, and the fourth pairs may further be rotated about the central axis in a common angular direction by a predetermined angle relative to the alignment axes of the first, the third, and the second pairs, respectively. The predetermined angle may be about 45 degrees. In some variations, the tilt of the microphone capsules may be arranged relative to the common angular direction of the rotation of the axes. For example, for each of the first and the third pairs, the first and the second maximum sensitivity vectors may be pivoted about the alignment axis away from the common angular direction, and for each of the second and the fourth pairs, the first and the second maximum sensitivity vectors may be pivoted about the alignment axis towards the common angular direction. In another example, the maximum sensitivity vectors may be arranged in the opposite directions.

In each of the examples above, an additional bidirectional microphone capsule may be added which has a maximum sensitivity vector aligned with or parallel to the central axis. For example, the bidirectional microphone capsule may be nested between the third and the second microphone capsules along the central axis.

An example method may include converting, with one or more integrated circuits, a first base set of audio signals from the first and the second pairs of the microphone capsules to a first set of B-format signals, and converting a second base set of audio signals from the third and the fourth pairs of the microphone capsules to a second set of B-format signals. The method may further include processing the first and the second sets of B-format signals based on an angle between the first and the third pairs to generate a third set of first-order and/or second-order B-format signals.

These as well as other novel advantages, details, examples, features and objects of the present disclosure will be apparent to those skilled in the art from following the detailed description, the attached claims and accompanying drawings, listed herein, which are useful in explaining the concepts discussed herein.

### BRIEF DESCRIPTION OF THE DRAWINGS

Some features are shown by way of example, and not by limitation, in the accompanying drawings. In the drawings, like numerals reference similar elements.

FIG. 1 illustrates an example system architecture that may be used to implement one or more illustrative aspects described herein.

FIG. 2 illustrates a perspective view of an example ambisonic microphone that may be used to implement one or more illustrative aspects described herein.

FIG. 3a illustrates an example geometric representation of a plurality of microphone capsules of the example ambisonic microphone of FIG. 2 that may be used to implement one or more illustrative aspects described herein.

FIG. 3b illustrates another example geometric representation of a plurality of microphone capsules of the example ambisonic microphone of FIG. 2 that may be used to implement one or more illustrative aspects described herein.

FIGS. 4a-4d illustrate left, front, top-down, and perspective views, respectively, of an example ambisonic microphone that may be used to implement one or more illustrative aspects described herein.

FIGS. 5a-5g illustrate left, front, top-down, and perspective views, respectively, of an example ambisonic microphone that may be used to implement one or more illustrative aspects described herein.

FIGS. 6a-6d illustrate left, front, top-down, and perspective views, respectively, of an example ambisonic microphone that may be used to implement one or more illustrative aspects described herein.

FIGS. 7a-7d illustrate left, front, top-down, and perspective views, respectively, of an example ambisonic microphone that may be used to implement one or more illustrative aspects described herein.

FIGS. 8a-8d illustrate left, front, top-down, and perspective views, respectively, of an example ambisonic microphone that may be used to implement one or more illustrative aspects described herein.

FIG. 9 illustrates an example system architecture that may be used to implement one or more illustrative aspects described herein.

FIG. 10 illustrates an example flowchart of a method that may be performed to implement one or more illustrative aspects described herein.

### DETAILED DESCRIPTION

In the following description of the various examples, reference is made to the accompanying drawings, which form a part hereof, and in which is shown by way of illustration various examples in which aspects may be practiced. References to “embodiment,” “example,” and the like indicate that the embodiment(s) or example(s) of the invention so described may include particular features, structures, or characteristics, but not every embodiment or example necessarily includes the particular features, structures, or characteristics. Further, it is contemplated that certain embodiments or examples may have some, all, or none of the features described for other examples. And it is to be understood that other embodiments and examples may be utilized and structural and functional modifications may be made without departing from the scope of the present disclosure.

Unless otherwise specified, the use of the serial adjectives, such as, “first,” “second,” “third,” and the like that are used to describe components, are used only to indicate different components, which can be similar components. But the use of such serial adjectives is not intended to imply that the components must be provided in given order, either temporally, spatially, in ranking, or in any other way, unless otherwise specified.

Also, while the terms “front,” “back,” “side,” and the like may be used in this specification to describe various example features and elements, these terms are used herein as a matter of convenience, for example, based on the example orientations shown in the figures and/or the orientations in typical use. Nothing in this specification should be construed as requiring a specific three dimensional or spatial orientation of structures in order to fall within the scope of the claims.

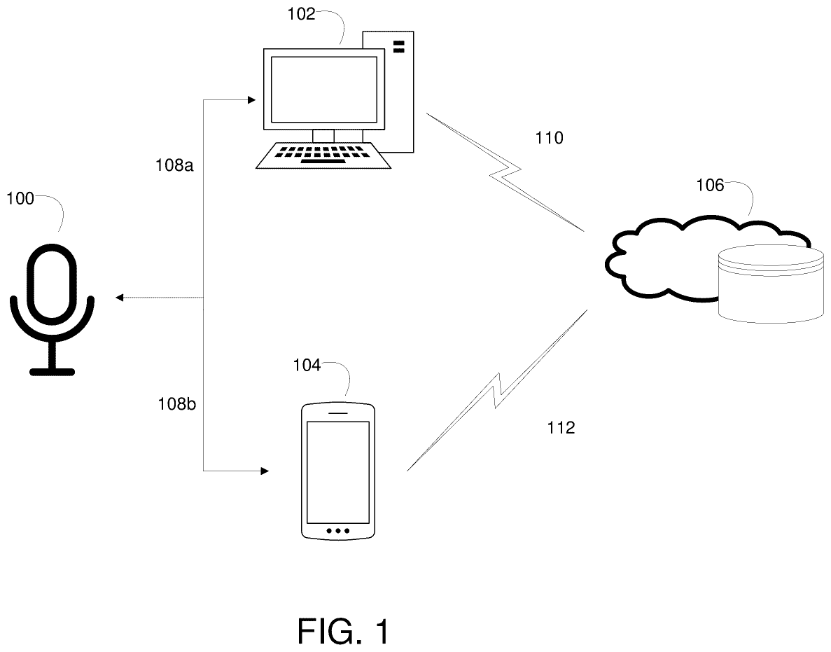

FIG. 1 illustrates an example of a system architecture that may be used to implement one or more illustrative aspects described herein in a standalone and/or networked environment. Device 100 may be an ambisonic microphone. Device 102 may be one or more computing devices, such as a desktop computer, a laptop computer, one or more cloud computing devices, one or more servers, etc. Device 104 may be a smartphone or tablet. Device 100 may be connected (wired or wirelessly) to and/or in communication with one or more of devices 102 and/or 104. In one or more examples, device 106 may comprise a data server, such as a cloud-based data server. Device 100 may be connected (wired or wirelessly) to and/or in communication with one or more other devices (not shown) including, but not limited to, a mixing console, a recording console, and the like. Any one or more of devices 100, 102, 104, and 106 may be any type of known computer or server. In one or more examples, device 102 and/or device 104 may include a user interface, such as a graphical user interface, to allow a user to interact with the system. Devices 100, 102, 104, and/or 106 may be interconnected via a wide area network (WAN), such as the Internet, and/or via any other network. For example, one or more other networks may also or alternatively be used, such as a local area network (LAN), a wireless network, a personal network (PAN), and the like. Devices 100, 102, 104, and/or 106, and/or other devices (not shown), may or might not be communicatively connected to one or more networks via twisted pair wires, coaxial cable, fiber optics, radio waves, and/or other communication media. In one or more examples, device 100 may be communicatively connected to device 102 and/or device 104 via connections 108a and/or 108b, respectively. Device 102 and/or device 104 may connect to device 100 via connections 108a and/or 108b using any one or more of a variety of different connectors, such as a LEMO connector, an XLR connector, a Lightning® connector, a TQG connector, a TRS connector, a USB connector (including, but not limited to, USB type A, type B, type C, Mini B, Micro B), and/or one or more RCA connectors. Connections 108a and/or 108b may be wireless and connect to the device 100 using any one or more protocols, such as WiMAX, LTE, Bluetooth, Bluetooth Broadcast, Bluetooth Low Energy, (BLE), GSM, 3G, 4G, 5G, 6G, Zigbee, 60 GHz Wi-Fi, Wi-Fi (e.g., compatible with IEEE 802.11a/b/g/n/ac/ad/af/ah/ai/aj/aq/ax/ay/ba/be), one or more proprietary wireless connection protocols, one or more NFC protocols, and/or any other protocol(s). Where the connection is wireless, devices 102 and 104 (and/or their respective transmitters, receivers, or transceivers) and device 100 may include a wireless communications interface. In one or more examples, device 102 may be communicatively connected to device 106 via connection 110, and/or device 104 may be communicatively connected to device 106 via connection 112 (e.g., via wired and/or wireless networks).

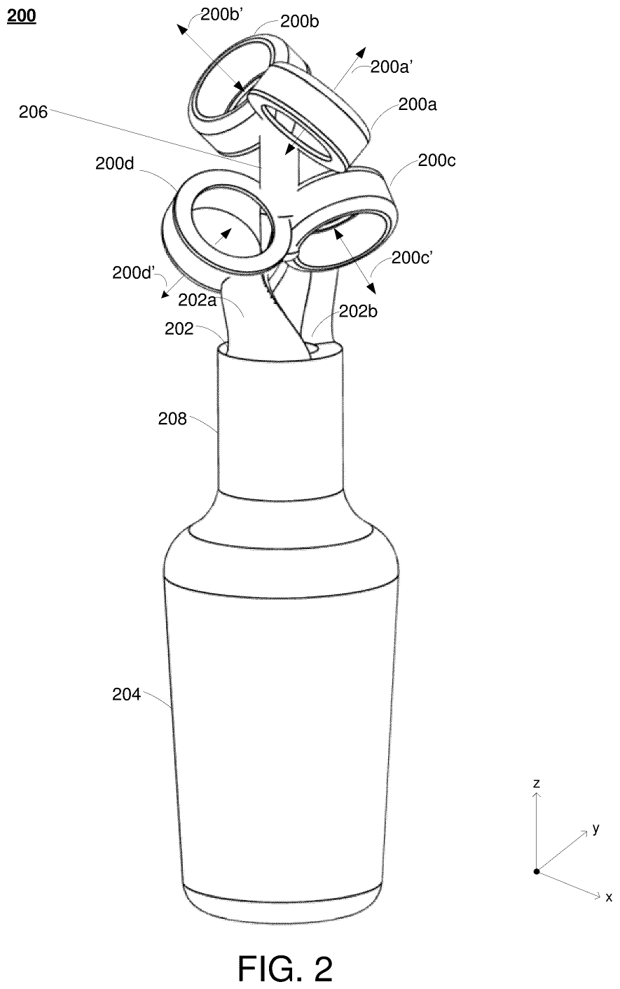

FIG. 2 illustrates a perspective view of an example ambisonic microphone 200 (hereinafter referred to as “microphone 200”) that may be used to implement one or more illustrative aspects described herein (e.g., microphone 100). Microphone 200 may include microphone capsules 200a-200d (hereinafter collectively referred to as “microphone capsules”). Microphone 200 may include any quantity of microphone capsules, such as more or less than microphone capsules 200a-200d. The microphone capsules may be any type of capsule, such as condenser (e.g., including large-and small-diaphragm and electret condenser), dynamic (e.g., including moving coil and ribbon microphones), and/or micro-electromechanical systems (MEMS), among others. The microphone capsules may be constructed according to one or more geometries (e.g., round, oval, elliptical, rectangular, etc.). The microphone capsules may have unidirectional, cardioid, supercardioid, hypercardioid, and/or bidirectional pickup patterns.

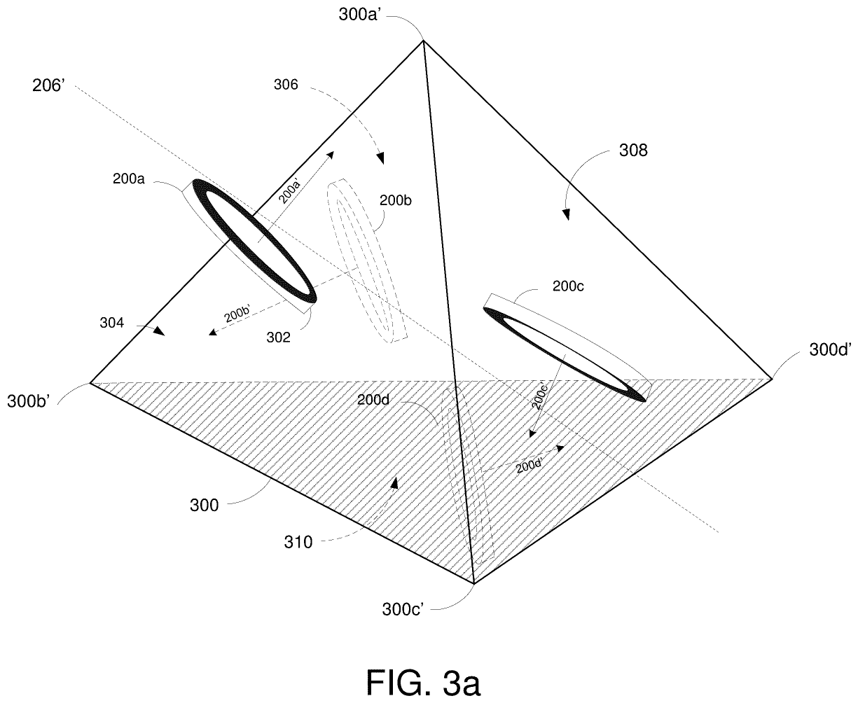

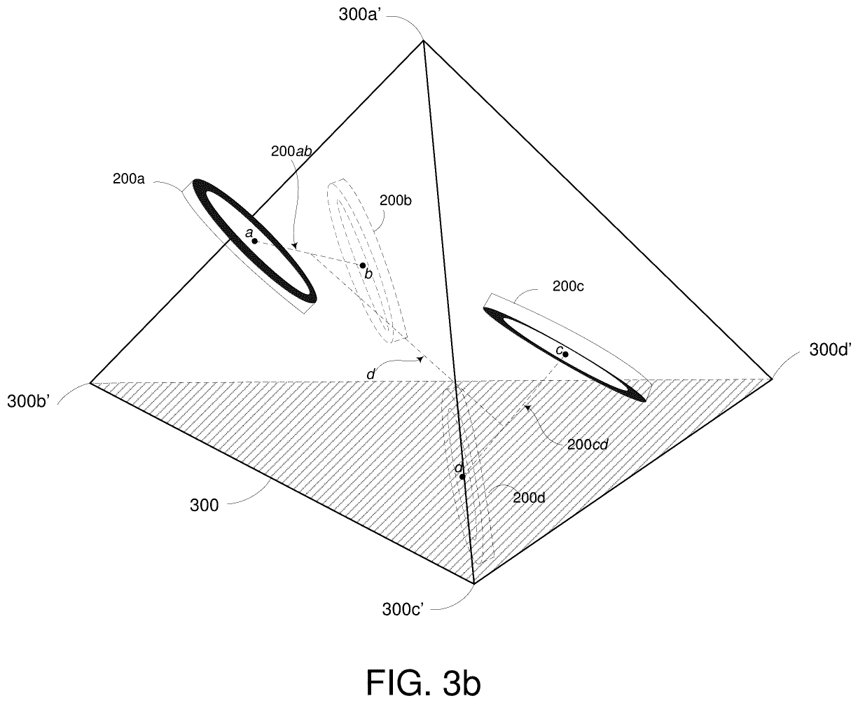

Microphone 200 may include yoke 202. Yoke 202 may be constructed according to one or more shapes and/or geometries. Yoke 202 may include a protruding member 206. Protruding member 206 may be constructed according to one or more shapes or geometries. Member 206 may be substantially columnar. One or more of the microphone capsules may be coupled to yoke 202 along protruding member 206. One or more of the microphone capsules may be electrically connected to yoke 202 and/or protruding member 206. Protruding member 206 may define a substantially vertical axis (e.g., central axis, further described with respect to FIG. 3) along which the microphone capsules may be disposed. The microphone capsules may be integrally molded to member 206 or detachably coupled to member 206. The microphone capsules may be rotatably and/or pivotably coupled to member 206 such that a user may variably rotate capsules about member 206 (e.g., about the z-axis) and/or pivot the direction of microphone capsules (e.g., along an axis parallel to the x-y plane). Microphone 200 may include a handle 204. Handle 204 may include a neck 208. Yoke 202 may be coupled to handle 204 at neck 208. Yoke 202 may be electrically connected to handle 204 and/or neck 208. Yoke 202 may be integrally molded to handle 204. Yoke 202 may be detachably coupled to handle 204. Yoke 202 may include one or more legs, such as 202a and 202b. Legs 202a and 202b may be integrally molded to handle 204 and may be electrically connected to handle 204. Legs 202a and 202b may be detachably coupled to handle 204. Legs 202a and/or 202b may be rotatably (e.g., about the z-axis) and/or pivotably coupled (e.g., along an axis parallel to the x-y plane) to handle 204, which may allow a user to rotate and/or pivot the orientation of one or more of the microphone capsules about the neck 208 of handle 204. Yoke 202 may be configured to swivel on the neck 208 of handle 204. Yoke 202 and/or member 206 may house some or all of the electronic components described and discussed herein.

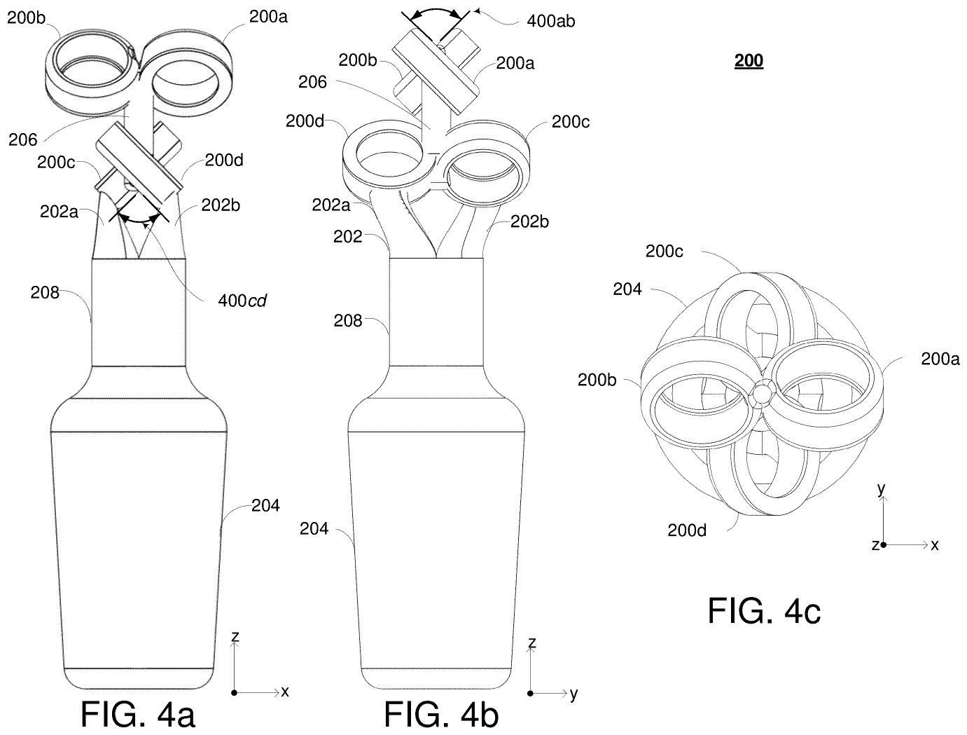

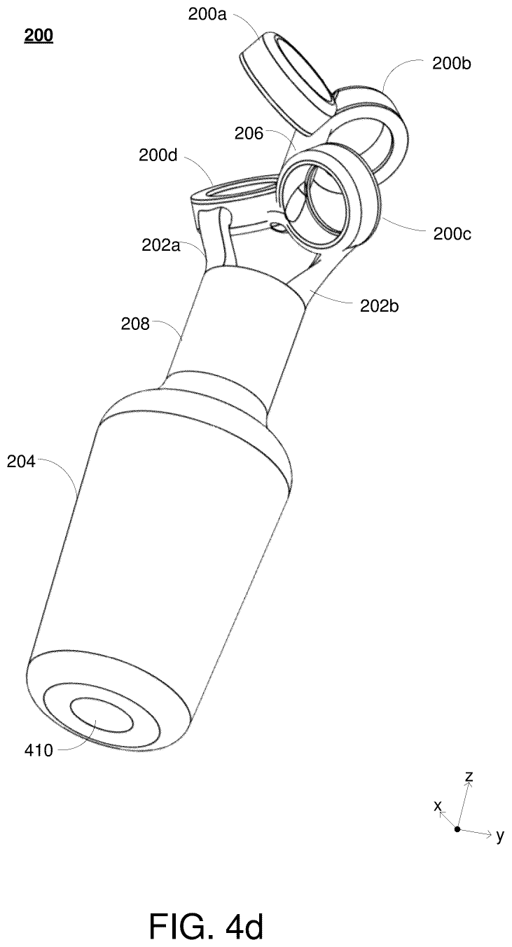

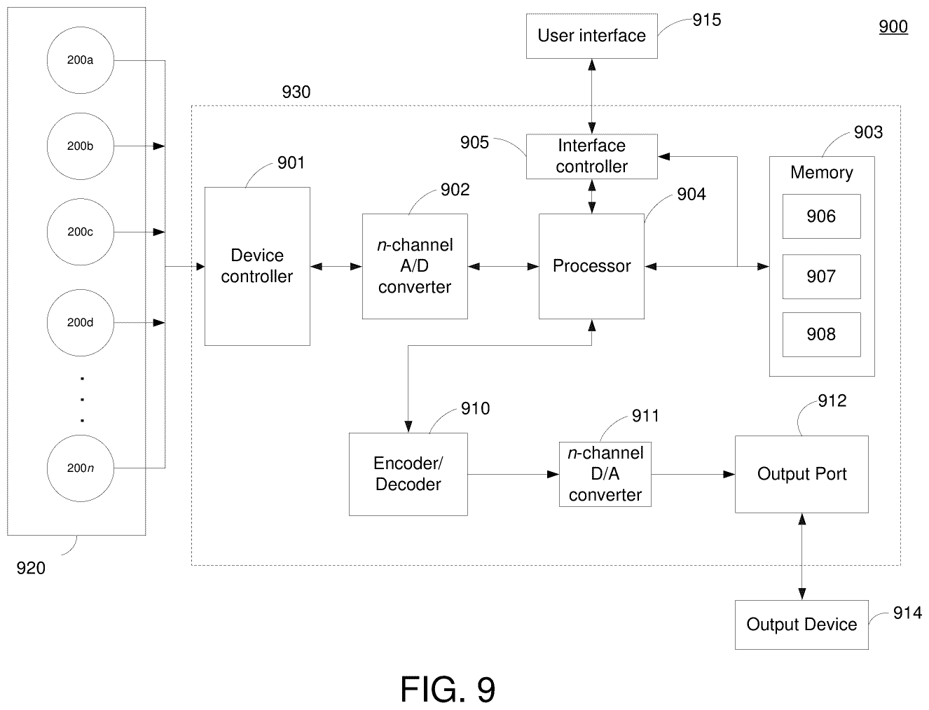

Handle 204 and/or neck 208 may be constructed according to any number of shapes or geometries. Handle 204 may be adapted for handheld use and may be constructed according to a number of ergonomic geometries. Handle 204 and/or neck 208 may house some or all of the electronic components described and discussed herein (e.g., system 900). Handle 204 may be adapted as a mounting fixture compatible with one or more cameras or stands, including tripod stands (discussed in greater detail with respect to FIG. 4d). Handle 204 may be adapted for both handheld use and as a mounting fixture. Handle 204 and/or neck 208 may include an output port 912 (discussed with respect to FIG. 9) electrically connected to n-channel D/A converter 911, memory 903, and/or processor 904 (also discussed with respect to FIG. 9).

Microphone capsule 200a may be positioned in a direction indicated by line 200a′. Microphone capsule 200b may be positioned in a direction indicated by line 200b′. Microphone capsule 200c may be positioned in a direction indicated by line 200c′. Microphone capsule 200d may be positioned in a direction indicated by line 200d′. Lines 200a′, 200b′, 200c′, and 200d′ may represent an axis of maximum sensitivity (e.g., an axis through the center of the microphone capsule projecting infinitely in the positive direction) and/or minimum sensitivity (i.e., said axis projecting infinitely in the negative, or opposite, direction) for microphone capsules 200a, 200b, 200c, and 200d, respectively. In some examples, axes of minimum sensitivity of microphone capsules 200a and 200d (i.e., along lines 200a′ and 200d′, respectively) may intersect at a point in space (i.e., lines 200a′ and 200d′ may share at least one coincident point of intersection). In some examples, axes of minimum sensitivity of microphone capsules 200b and 200c (i.e., along lines 200b′ and 200c′, respectively) may intersect at a point in space (i.e., along lines 200b′ and 200c′ may share at least one coincident point of intersection).

Microphone capsules 200a-200d may be geometrically arranged and compactly nested relative to one another such that the microphone capsules may exhibit a consistent and/or stable polar response at high frequencies. The microphone capsules may be compactly nested together to help minimize phase-related errors and/or to help provide higher spatial/localization accuracy. The microphone capsules may be geometrically oriented according to aspects described herein to reduce the acoustic shading due to structural interference introduced by one or more adjacent microphone capsules. That is, the geometric orientation of the microphone capsules may reduce acoustic shading by reducing the cross-section(s) of the obstruction caused by adjacent microphone capsules, which may help improve high frequency response.

FIG. 3a illustrates an example geometric representation of the orientations of microphone capsules 200a-200d of ambisonic microphone 200 about notional tetrahedron 300. Notional tetrahedron 300 may assume the geometry of any number of types of tetrahedra. Notional tetrahedron 300 may be a regular tetrahedron, in which all four triangular faces are equilateral triangles and all edges are the same length. Notional tetrahedron 300 may be an irregular tetrahedron, an isosceles tetrahedron, or a trirectangular tetrahedron, etc.

As shown in FIG. 3a, the microphone capsules may be oriented on one of four respective triangular faces of notional tetrahedron 300. For example, microphone capsule 200a may be disposed at the centroid (i.e., the point at which three medians of a triangular face of the tetrahedron intersect) of a face 304 of notional tetrahedron 300. Microphone capsule 200a may be disposed at any number of points on face 304. Face 304 may be defined by vertices 300a′, 300b′ and 300c′. Microphone capsule 200a may include an outer edge 302 that defines an outer perimeter of microphone capsule 200a. Edge 302 of microphone capsule 200a may be parallel to face 304 of tetrahedron 300. Microphone capsule 200a may be oriented such that the capsule generally faces the direction of vertex 300a′ (represented by line 200a′, e.g., an axis of maximum sensitivity). Line 200a′ might not intersect vertex 300a′. The face of microphone capsule 200a (e.g., the side of the microphone capsules corresponding to maximum acoustic sensitivity) may define a plane that is substantially (e.g., +10 degrees) orthogonal (e.g., perpendicular) to the plane defined by the corresponding face 304. Stated differently, line 200a′ may be substantially parallel (e.g., +10 degrees) to the plane defined by face 304. In an example, the face of microphone capsule 200a might not be orientated orthogonally relative to face 304. Microphone capsule 200a may be disposed on face 304 of notional tetrahedron 300 such that the plane defined by face 304 intersects one or more points of capsule 200a (e.g., edge 302 of capsule 200a might not be tangent to face 304).

Microphone capsule 200b may or might not be disposed at the centroid of face 306. Microphone capsule 200b may be disposed at any number of points on face 306. Face 306 may be defined by vertices 300a′, 300b′, and 300d′. Microphone capsule 200c may or might not be disposed at the centroid of face 308. Capsule 200c may be disposed at any number of points on face 308. Face 308 may be defined by vertices 300a′, 300c′, and 300d′. Capsule 200d may or might not be disposed at the centroid of face 310. Capsule 200d may be disposed at any number of points on face 310. Face 310 may be defined by vertices 300b′, 300c′, and 300d′. Capsules 200b-200d may include respective edges that are tangent to faces 306, 308, and 310, respectively, of notional tetrahedron 300. Microphone capsule 200b may be disposed on face 306 of notional tetrahedron 300 such that the plane defined by face 306 intersects one or more points of capsule 200b (e.g., edge of capsule 200b might not be tangent to face 306). Microphone capsule 200c may be disposed on face 308 of notional tetrahedron 300 such that the plane defined by face 308 may intersect one or more points of capsule 200c (e.g., edge of capsule 200c might not be tangent to face 308). Microphone capsule 200d may be disposed on face 310 of notional tetrahedron 300 such that the plane defined by face 310 may intersect one or more points of capsule 200d (e.g., edge of capsule 200d might not be tangent to face 310).

Microphone capsule 200b may be oriented in a direction substantially towards vertex 300b′ (represented by line 200b′, e.g., an axis of maximum sensitivity). Capsule 200c may be oriented in a direction substantially towards vertex 300c′ (represented by line 200c′, e.g., an axis of maximum sensitivity). Capsule 200d may be oriented in a direction substantially towards vertex 300d′ (represented by line 200d′, e.g., an axis of maximum sensitivity). The faces (e.g., the side of the microphone capsules corresponding to maximum acoustic sensitivity) of microphone capsules 200b, 200c, and 200d may each define a plane that is substantially (e.g., +10 degrees) orthogonal (i.e., perpendicular) to the plane defined by the corresponding face of notional tetrahedron 300 (i.e., face 304 for capsule 200a, face 306 for capsule 200b, face 308 for capsule 200c, and face 310 for capsule 200d). In an example, the faces of microphone capsules 200b, 200c, and/or 200d might not be orientated orthogonally relative to faces 306, 308, and/or 310, respectively. The faces of microphone capsules 200b, 200c, and/or 200d may be oriented parallel to faces 306, 308, and/or 310, respectively. The faces of microphone capsules 200b, 200c, and/or 200d may be oriented parallel and substantially tangent to faces 306, 308, and/or 310, respectively.

As has been discussed, microphone capsules 200a-200d may be compactly nested with respect to one another which may help ensure a consistent polar response of the microphone capsules at high frequencies and may help reduce phase-related errors. Microphone capsules 200a-200d may be geometrically arranged to help reduce acoustic shading that any one microphone capsule is subjected to from the other microphone capsules. While the microphone capsules may be generally oriented or arranged as described above, the distances between any two given microphone capsules may vary (e.g., may vary widely).

For example, as show in FIG. 3b, the center a of microphone capsule 200a and the center b of capsule 200b may be at the same vertical height and horizontally spaced from one another by a distance ab (represented by line 200ab). The center c of microphone capsule 200c and the center d of capsule 200d may be at the same vertical height and horizontally spaced from one another by a distance cd (represented by line 200cd). Distances ab and cd may be dictated by the particular geometry of notional tetrahedron 300 (i.e., whether notional tetrahedron is a regular tetrahedron, irregular tetrahedron, isosceles tetrahedron, etc.). The distance ab may be approximately twice the radius (or width, as the case may be) of microphone capsules 200a or 200b measured from their respective centers to their respective outer diameters (or perimeters, as the case may be). The distance cd may be approximately twice the radius (or width) of microphone capsules 200c or 200d measured from their respective centers to their respective outer diameters (or perimeters). The distance ab and/or cd may be more than approximately twice the radius (or width) of microphone capsules 200a or 200b and 200c or 200d, respectively. While points a, b, c, and d, are described above as being at the centers of the respective microphone capsules, these points may be at other locations within the capsules, such as at a point on an axis of maximum sensitivity.

Microphone capsules 200a and 200b may be offset from microphone capsules 200c and 200d by a distance d along a z-axis of member 206 (as shown in FIG. 2 and represented by line 206′ in FIG. 3a). Member 206 may comprise a yoke. Distance d may be dictated by the particular geometry of notional tetrahedron 300 (i.e., whether notional tetrahedron is a regular tetrahedron, irregular tetrahedron, isosceles tetrahedron, etc.). Distance d may be approximately twice the radius (or width) of microphone capsules 200a, 200b, 200c, or 200d measured from their respective centers to their respective outer diameters (or perimeters, as the case may be). Distance d may be more or less than approximately twice the radius (or width) of microphone capsules 200a, 200b, 200c, or 200d measured from their respective centers to their respective outer diameters (or perimeters).

As has been discussed, notional tetrahedron 300 may assume the shape of an irregular tetrahedron (i.e., a tetrahedron that does not have four equilateral face). In an example, microphone capsules 200a, 200b, 200c, and 200d may be generally disposed on the faces of notional tetrahedron 300 at a constant radius from a central point such that the array of microphone capsules is radially symmetric when projected onto a plane. The faces of capsules 200a, 200b, 200c, and 200d may be equally spaced relative to one another and may form an angle of about 90 degrees relative to adjacent capsules. Capsules 200a, 200b, 200c, and 200d may be arranged into a first and second vertical plane, such that each vertical plane contains two microphone capsules that share an intersecting axis. Each pair of microphone capsules may be rotated about the respective shared axis such that the respective axes of maximum sensitivity are orthogonal. The second vertical plane may be rotated about 90 degrees and mirrored about its axis of rotation. As a result, microphone capsules 200a, 200b, 200c, and 200d may be substantially outward-facing. The respective axes of maximum sensitivity of microphone capsules 200a, 200b, 200c, and 200d might not overlap. The upper pair of microphone capsules may be largely upward-facing (e.g., having the axis of maximum sensitivity pointing at an angle from the z-axis in the positive z direction) and the lower pair of microphone capsules may be largely downward-facing (e.g., having the axis of maximum sensitivity pointing at an angle from the z axis in the negative z direction).

FIGS. 4a, 4b, 4c, and 4d illustrate various side and perspective views of microphone 200. FIG. 4a illustrates a left-side view of ambisonic microphone 200. The faces of microphone capsules 200c and 200d (i.e., the sides of microphone capsules 200c and 200d that correspond to the maximum acoustic sensitivity of capsules 200c and 200d) may be oriented substantially downward-facing. The faces of capsules 200c and 200d may be oriented relative to one another to form an angle 400cd of about 70 degrees). The faces of capsules 200c and 200d may be oriented relative to one another to form an angle 400cd of more or less than 70 degrees (for example, from 65 degrees to 95 degrees).

FIG. 4b illustrates a front view of the ambisonic microphone 200. The faces of microphone capsules 200a and 200b (i.e., the sides of microphone capsules 200a and 200b that correspond to the maximum acoustic sensitivity of capsules 200a and 200b) may be oriented substantially upward-facing. The faces of capsules 200a and 200b may be oriented relative to one another to form an angle 400ab of about 70 degrees. The faces of capsules 200a and 200b may be oriented relative to one another to form an angle 400ab of more or less than 70 degrees (for example, from 65 degrees to 95 degrees). As illustrated in FIGS. 4a and 4b, microphone capsules 200a and 200b may be located at a first location along member 206 (e.g., at a first vertical height, centered in a first plane perpendicular to the z-axis, etc.), and microphone capsules 200c and 200d may be located at a second location along member 206 (e.g., at a second vertical height, centered in a second plane perpendicular to the z-axis, etc.), which is different than the first location.

FIG. 4c illustrates a top-down view of the ambisonic microphone 200. As shown, microphone capsules 200a and 200b may be located along a first axis perpendicular to member 206 (e.g., a first horizontal axis, with center points of capsules 200a and 200b intersecting the first axis, etc.), and microphone capsules 200c and 200d may be located along a second axis perpendicular to member 206 (e.g., second horizontal axis, with center points of capsules 200c and 200d intersecting the second axis, etc.). The first axis and the second axis may be about 90 degrees with respect to each other.

With respect to FIG. 4d, handle 204 may be adapted as a mounting fixture compatible with one or more cameras or stands (not shown). Microphone 200 may be used in combination with a camera and/or camera array that may be configured to produce a 360-degree field-of-view, such as a camera and/or camera array used for virtual reality applications and/or 360-degree video. Handle 204 may include a coupling mechanism 410 adapted to couple in any number of ways to any number of camera mounts, stands, etc. Coupling mechanism 410 may be threaded. Coupling mechanism 410 may be configured with ball bearings, etc., to allow microphone 200 to swivel when mated with a camera mount or stand. Coupling mechanism 410 may include a ratchet-style assembly (not shown) to allow a user to variably and securely position microphone 200 in a desired orientation respective to the camera array and/or camera stand.

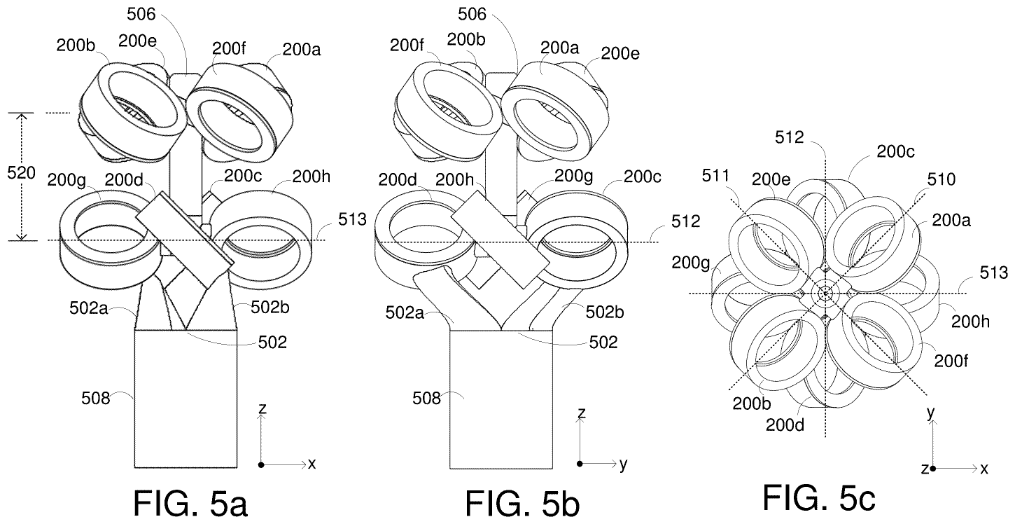

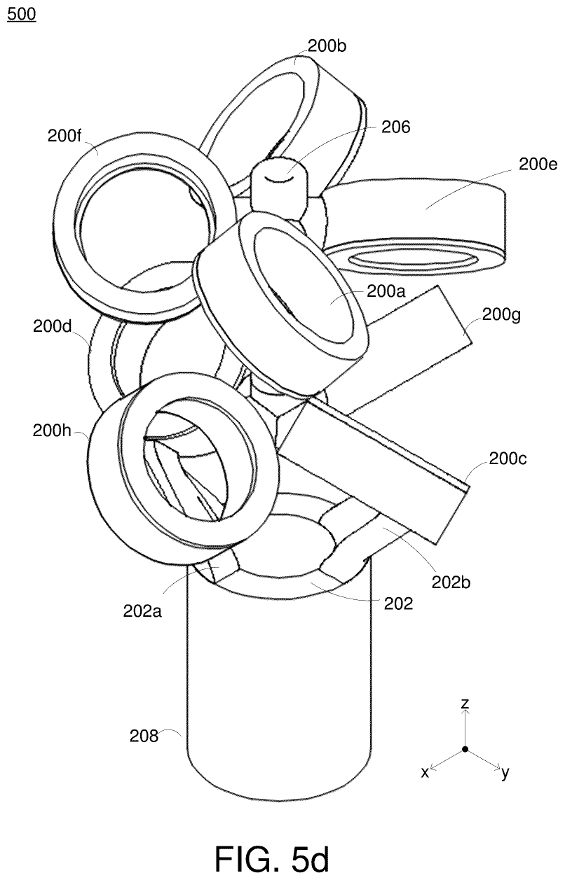

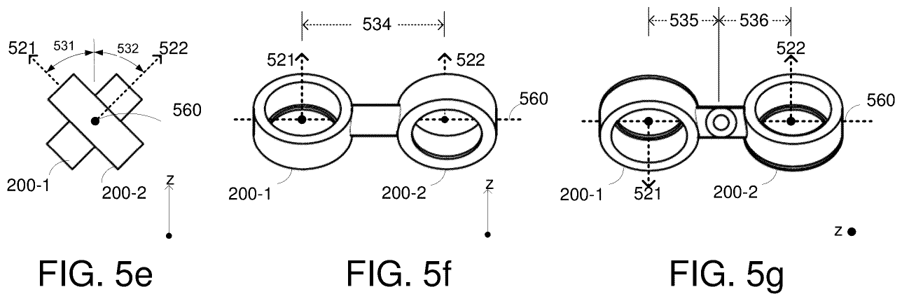

FIGS. 5a-5g illustrate various views of microphone 500 that may be used to implement one or more illustrative aspects described herein (e.g., microphone 100). For example, FIG. 5a illustrates a left view, FIG. 5b illustrates a front view, FIG. 5c illustrates a top view, and FIG. 5d illustrates a perspective view of microphone 500. FIGS. 5e-5g further illustrates detailed view of a pair of microphone capsules within microphone 500. FIGS. 5a-5g include references to a cartesian coordinate system having x, y, and z axes, which are included for the purpose of illustrating and describing the relative arrangement of elements to each other. These axes do not represent absolute position of microphone 500 or its elements with respect to a surrounding environment in which the microphone might be positioned.

Microphone 500 may include microphone capsules 200a-h, which may be the same as, or similar to, those described above with respect to FIGS. 2 to 4d. The microphone capsules may be any type of capsule, such as condenser (e.g., including large- and small-diaphragm and electret condenser), dynamic (e.g., including moving coil and ribbon microphones), and/or micro-electromechanical systems (MEMS), among others. The microphone capsules may be constructed according to one or more geometries (e.g., round, oval, elliptical, rectangular, etc.). The microphone capsules may have unidirectional, cardioid, supercardioid, hypercardioid, and/or bidirectional pickup patterns.

As illustrated in FIGS. 5a, 5b, and 5d, microphone 500 may include yoke 502. Yoke 502 may be constructed according to one or more shapes and/or geometries. Yoke 502 may include a support 506, which may be constructed according to one or more shapes or geometries (e.g., a columnar post). One or more of the microphone capsules 200a-200h may be coupled (e.g., by a cross-member) to yoke 502 along support 506 (which may be the same or similar to a protruding member such as member 206 described above). One or more of the microphone capsules may be electrically connected to yoke 502 and/or support 506.

Support 506 may define a substantially central axis (e.g., a z-axis, a vertical axis) along which the microphone capsules may be disposed. The microphone capsules may be integrally molded to support 506 or detachably coupled to support 506. The microphone capsules may be rotatably and/or pivotably coupled to support 506 such that a user may variably rotate capsules about support 506 (e.g., about the z-axis) and/or pivot the direction of microphone capsules (e.g., along an axis parallel to the x-y plane) as further described with respect to FIGS. 5e-5g below.

Microphone 500 may include a neck 508 (e.g., attached to a handle 204 (not illustrated) as described above with respect to microphone 200). Yoke 502 may be coupled to neck 508 and may be electrically connected to neck 508. Yoke 502 may be integrally molded or detachably coupled to neck 508. Yoke 502 may include one or more legs, such as 502a and 502b, which may be integrally molded to neck 508 and may provide electrical connections between microphone capsules 200a-200h and neck 508 (and/or a handle coupled to neck 508). Legs 502a and/or 502b may be rotatably (e.g., about the z-axis) and/or pivotably coupled (e.g., along an axis parallel to the x-y plane) to handle 204, which may allow a user to rotate and/or pivot the orientation of one or more of the microphone capsules about the neck 508. Yoke 502 may be configured to swivel on the neck 508. Neck 508, yoke 502, and/or support 506 may house some or all of the electronic components described and discussed herein. Neck 508 may include all of the features and have the same or similar functions as described above with respect to neck 208 in microphone 200.

As shown in FIGS. 5a-5d, the microphone capsules may be arranged in four pairs, a first pair including 200a and 200b, a second pair including 200e and 200f, a third pair including 200c and 200d, and a fourth pair including 200g and 200h. Microphone capsules 200a-200d of the first and the third pairs may form a base set of microphone capsules, arranged the same as or similar to the set of microphone capsules 200a-200d, respectively, of microphone 200 as illustrated in FIGS. 2, 3a, 3b, and 4a-4d. Microphone capsules 200e-200h of the second and the fourth pairs may form a second base set of microphone capsules that are arranged the same as or similar to microphone capsules 200a-200d but rotated 90 degrees (e.g., counterclockwise from the top view) about support 506 (e.g., about the central axis). In some examples, within the first base set, microphone capsules 200a and 200b may be rotated by 90 degrees with respect to microphones 200c and 200d about the central axis, and within the second base set, microphone capsules 200e and 200f may be rotated by 90 degrees with respect to microphones 200g and 200h about the central axis. In other examples, such the one illustrated in FIGS. 5a-5d, within the first base set, microphone capsules 200a and 200b may be rotated by 45 degrees with respect to microphones 200c and 200d about the central axis, and within the second base set, microphone capsules 200e and 200f may be rotated by 45 degrees with respect to microphones 200g and 200h about the central axis.

The first pair may be arranged along a first axis 510, the second pair may be arranged along a second axis 511, the third pair may be arranged along a third axis 512, and the fourth pair may be arranged along a fourth axis 513. The first pair and the second pair may further be arranged into a first quartet of nested microphone capsules, and the third pair and the fourth pair may be arranged into a second quartet of nested microphone capsules. In some examples, the first quartet may be positioned in or about a first plane (e.g. a first horizontal plane) that is tangent to support 506 (e.g., with axes 510 and 511 in a plane tangent to the z-axis or vertical axis or central axis) and the second quartet may be positioned in or about a second plane (e.g. a second horizontal plane) that is tangent to support 506 (e.g., with axes 510 and 511 in a plane tangent to the central or vertical axis). The first plane and the second plane may be offset by a distance 520 (e.g., as shown in FIG. 5a), wherein the distance is configured to provide a temporal difference between the first quartet and the second quartet in receiving sound originating in the central or vertical direction. This configuration may enable microphone 500 to distinguish sound in the z-direction from sounds from other directions and to determine whether the sound originates from a positive or negative central-axis or vertical direction. In some examples, distance 520 may be less than the diameter of the microphone capsules, because the tilt of the capsule allows them to be spaced closer together (e.g., nested) in the z-axis direction.

As shown in FIGS. 5a-5c, axis 510 may be at an angle (e.g., 90 degrees) with axis 511 in the first plane and may intersect with axis 511 at or near the center of support 506 (e.g., where x=0 and y=0). Similarly, axis 512 may be at an angle (e.g., 90 degrees) with axis 513 in the second plane and may intersect axis 513 at or near the center of support 506 (e.g., where x=0 and y=0). In some examples, from the top view, axes 510 and 511 (e.g., which are offset from each other by 90 degrees) may be rotated by a predefined angle about the central axis (e.g., z-axis) with respect to axes 512 and 513 (e.g., which are offset from each other by 90 degrees). For example, as shown in FIG. 5c, axes 510 and 511 may be rotated by 45 degrees (e.g., clockwise) about the central axis with respect to axes 512 and 513. In other examples, from a top view, axis 510 and axis 512 may be parallel and aligned in a third (e.g., vertical) plane. Likewise, from the top view, axis 511 and axis 513 may be parallel and aligned in a fourth (e.g., vertical) plane. In some examples, the third and fourth planes are perpendicular to each other and intersect along the central axis (e.g., the z-axis or vertical axis) defined by the support 506.

FIGS. 5e-5g illustrate the relative positions of each microphone capsule in a pair of microphone capsules 200-1 and 200-2. In some embodiments, each pair of microphone capsules in microphone 500 (e.g., the first pair including 200a and 200b, the second pair including 200c and 200f, the third pair including 200c and 200d, and the fourth pair including 200c and 200f) may be arranged and have the same structure and function as microphone capsules 200-1 and 200-2, respectively.

Microphone capsules 200-1 and 200-2 may each have a sensitivity pattern (e.g., cardioid, supercardioid, hypercardioid, figure eight), with a direction of maximum sensitivity represented by vectors 521 and 522 respectively, and the tail of each vector positioned at the origin of the sensitivity pattern. As used herein, the center of the microphone capsule refers to the physical center location of the microphone, the origin of the microphone capsule's sensitivity pattern (e.g., the origin of the maximum sensitivity vector), or both the physical center location of the microphone and the origin of the microphone capsule's sensitivity pattern. As further used herein, the direction of a microphone capsule or the direction in which a microphone capsule points refers to the direction of the microphone capsule's maximum sensitivity vector.

Each of the microphone capsules 200-1 and 200-2 may be positioned such that the capsules' centers are located along an alignment axis 560 (e.g., axis 510-513) and separated by a distance 534. Distance 534 may be the sum of distances 535 and 536, which are the distances from the center axis of the maximum sensitivity vectors of microphone capsules 200-1 and 200-2 respectively. Microphone capsules 200-1 and 200-2 may further be pivoted about axis 560 such that the maximum sensitivity vectors 521 and 522 are perpendicular to the axis 560 and at angles 531 and 532, respectively, from a common plane. As illustrated in FIG. 5e, in some examples, the common plane may include the central axis (e.g., z or vertical axis). As illustrated in FIGS. 5e-5g, both maximum sensitivity vectors 521 and 522 may point towards the same z-direction (e.g., both in the positive or both in the negative z-direction) but in the opposite lateral direction perpendicular to axis 560. That is, the first and the second microphone capsules may be pivoted about the alignment axis in opposite directions by a common angle from a plane formed by the alignment axis and the central axis. In some examples, angles 531 and 532 may point upwards, with angles 531 and 532 of about 45 degrees, or in the range of 30 to 60 degrees. In some examples, angles 531 and 532 may point downwards, with angles 531 and 532 of about 135 degrees (45 degrees from the central axis in the negative direction), or in the range of 120-150 degrees (30-60 degrees from the central axis in the negative direction).

Returning to FIGS. 5a-5c, in some examples, the maximum sensitivity vectors for each of microphone modules 200a, 200b, 200c, and 200f point towards the positive z-direction (e.g., point upward, have angles 531 and 532 less than 90 degrees, and/or have positive z-values) and the maximum sensitivity vectors for each of microphone modules 200c, 200d, 200g, and 200h point towards the negative z-direction (e.g., point downward, have angles 531 and 532 greater than 90 degrees and/or have negative z-values) Further, the maximum sensitivity vectors for the first pair of microphone capsules 200a and 200b may point in opposite lateral directions perpendicular to axis 510, the maximum sensitivity vectors for the second pair of microphone capsules 200e and 200f may point in opposite lateral directions perpendicular to axis 511, the maximum sensitivity vectors for the third pair of microphone capsules 200c and 200d may point in opposite lateral directions perpendicular to axis 512, and the maximum sensitivity vectors for the fourth pair of microphone capsules 200g and 200h may point in opposite lateral directions perpendicular to axis 513.

As shown in top view of FIG. 5c, each of microphone capsules 200a, 200b, 200c, and 200f may point towards a different quadrant of the x-y plane. In some examples, microphone capsules 200c, 200d, 200g, and 200h may point in the same lateral directions (and opposite z-directions), as microphone capsules 200a, 200b, 200e, and 200f, respectively. In other examples, capsules 200c, 200d, 200g, and 200h may point in the opposite lateral directions (and opposite z-directions), as microphone capsules 200a, 200b, 200e, and 200f, respectively.

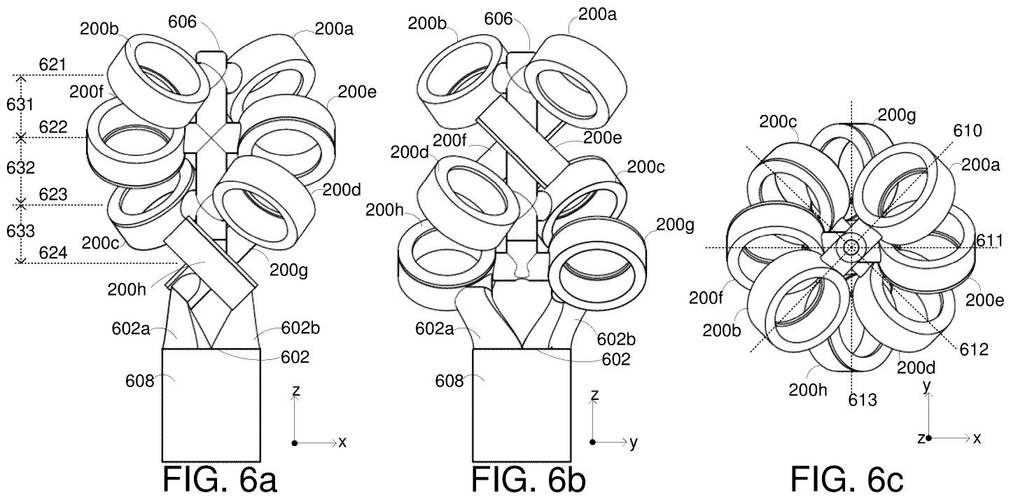

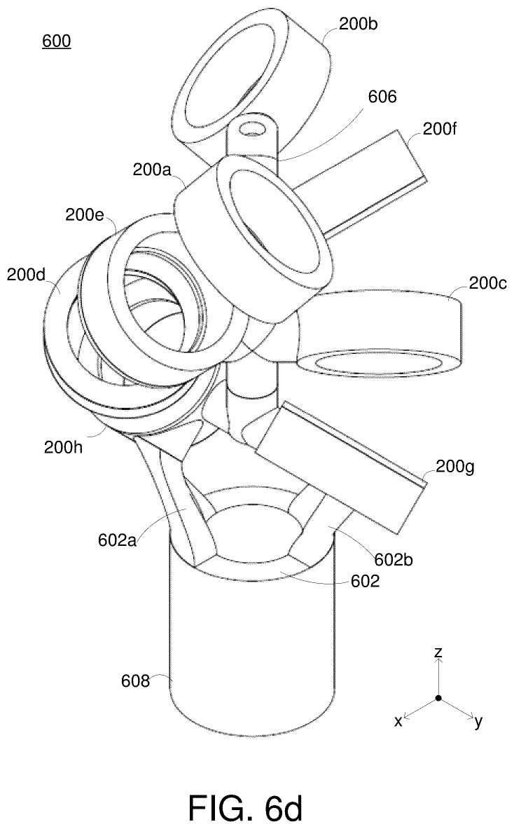

FIGS. 6a-6d illustrate various views of microphone 600 that may be used to implement one or more illustrative aspects described herein (e.g., microphone 100). For example, FIG. 6a illustrates a left view, FIG. 6b illustrates a front view, FIG. 6c illustrates a top view, and FIG. 6d illustrates a perspective view of microphone 600. Similar to FIGS. 5a-5d, FIGS. 6a-6d include references to a cartesian coordinate system having x, y, and z axes, which are included for the purpose of illustrating and describing the relative arrangement of elements to each other. These axes do not represent the absolute position of microphone 600 or its elements with respect to a surrounding environment in which the microphone might be positioned.

Microphone 600 may include microphone capsules 200a-200h, which may be the same as those described above with respect to FIGS. 5a-5g.

As illustrated in FIGS. 6a, 6b, and 6d, microphone 600 may include yoke 602. Yoke 602 may be constructed according to one or more shapes and/or geometries. Yoke 602 may include a support 606, which may be constructed according to one or more shapes or geometries (e.g., a columnar post). One or more of the microphone capsules 200a-200d may be coupled (e.g., by one or more cross-members or by coupling between capsules) to yoke 602 along support 606 (which may be the same or similar to protruding member 206 described above). One or more of the microphone capsules may be electrically connected to yoke 602 and/or support 606.

Support 606 may define a substantially central axis (e.g., z-axis, vertical axis) along which the microphone capsules may be disposed. The microphone capsules may be integrally molded to support 606 or detachably coupled to support 606. The microphone capsules may be rotatably and/or pivotably coupled to support 606 such that a user may variably rotate capsules about support 606 (e.g., about the central, z-axis) and/or pivot the direction of microphone capsules (e.g., along an axis parallel to the x-y plane) as further described with respect to FIGS. 6e-6d below.

Microphone 600 may include a neck 608, yoke 602 with one or more legs (e.g., 602a, 602b), and support 606, which include all of the features and have the same or similar functions as described above with respect to neck 508, yoke 502 with one or more legs (e.g., 502a, 502b), and support 506, respectively.

As shown in FIGS. 6a-6d, the microphone capsules may be arranged in four pairs, a first pair including 200a and 200b, a second pair including 200e and 200f, a third pair including 200c and 200d, and a fourth pair including 200g and 200h. Microphone capsules 200a-200d of the first and the third pairs may form a base set of microphone capsules, arranged the same as or similar to the set of microphone capsules 200a-200d, respectively, of microphone 200as illustrated in FIGS. 2, 3a, 3b, and 4a-4d. Microphone capsules 200e-200h of the second and the fourth pairs may form a second base set of microphone capsules that are arranged the same as or similar to microphone capsules 200a-200d, but rotated-45 degrees (e.g., clockwise from the top view) about support 506 and lowered (moved in the negative central, z-axis direction) by a predetermined distance (e.g., by distances 631 and 633).

As shown in the top view in FIG. 6c, the first pair may be arranged along a first axis 610, the second pair may be arranged along a second axis 611, the third pair may be arranged along a third axis 612, and the fourth pair may be arranged along a fourth axis 613. In distinction to microphone 500, in microphone 600, each pair of microphone capsules may be positioned in different planes that are tangent to support 606 (perpendicular to the central, z-axis). For example, as shown in FIG. 6a, the first pair may be positioned in a first plane 621, the second pair may be positioned in a second plane 622, the third pair may be positioned in a third plane 623, and the fourth pair may be positioned in a fourth plane 624. The planes may be sequentially spaced, such that planes 621 and 622 may be separated by a distance 631, planes 622 and 623 may be separated by a distance 632, and planes 623 and 624 may be separated by a distance 633. Each distance 631, 632, and 633 may be less than or equal to the diameter of the capsules because the microphone capsules are tilted, thus allowing the capsules to be nested in the z direction. Each of distances 631, 632, and 633 are configured to provide a temporal difference between the first, second, third, and/or fourth pairs in receiving sound originating in the z-axis or vertical axis or central axis direction. This enables microphone 600 to distinguish sound in the z-direction from sounds from other directions and determine whether the sound originates from a positive or negative central, z-axis or vertical direction.

As shown in the top view, in FIG. 6c, axis 610, 611, 612, and 613 may be at a different angle about support 606 (e.g., central axis, z-axis). In some example, each axis may be offset in a common angular direction by the same common/predetermined angle with respect to the axis in the plane above it. For example, axis 611 (in plane 622) may be rotated around the central axis (e.g., support 606) by about-45 degrees (clockwise) with respect to axis 610 (in plane 621), axis 612 (in plane 623) may be rotated around the central axis (e.g., support 606) by about-45 degrees (clockwise) with respect to axis 611 (in plane 622), and axis 613 (in plane 624) may be rotated around the central axis (e.g., support 606) by about-45 degrees (clockwise) with respect to axis 612 (in plane 623). While 45 degrees is used an example as illustrated in FIG. 6c, the angles may be rotated by other amounts, which may be the same or different for each axis.

In some embodiments, each pair of microphone capsules in microphone 600 (e.g., the first pair including 200a and 200b, the second pair including 200e and 200f, the third pair including 200c and 200d, and the fourth pair including 200g and 200h) may be arranged and have the same structure and function as microphone capsules 200-1 and 200-2 in FIGS. 5e-5g, respectively, as previously described, with axes 610-613 in FIGS. 6a-6c being the same as axis 560 in FIGS. 5e-5g.

In some examples, the maximum sensitivity vectors for the first pair of microphone capsules 200a and 200b may point towards opposite lateral directions perpendicular to axis 610, the maximum sensitivity vectors for the second pair of microphone capsules 200e and 200f may point towards opposite lateral directions perpendicular to axis 611, the maximum sensitivity vectors for the third pair of microphone capsules 200c and 200d may point towards opposite lateral directions perpendicular to axis 612, and the maximum sensitivity vectors for the fourth pair of microphone capsules 200g and 200h may point towards opposite lateral directions perpendicular to axis 613. Further, in some examples, the maximum sensitivity vectors for each of microphone modules 200a, 200b, 200c, and 200f point towards the positive z-direction (e.g., point upward, have angles 531 and 532 less than 90 degrees and/or have positive z-values) and the maximum sensitivity vectors for each of microphone modules 200c, 200d, 200g, and 200h point towards the negative z-direction (e.g., point downward, have angles 531 and 532 greater than 90 degrees and/or have negative z-values) As shown in the top view of FIG. 6c, angle 531 for capsules 200a, 200c, 200c, and 200g and angle 532 for capsules 200b, 200d, 200f, and 200h may each have the same predetermined value, or be may be offset by 180 degrees from the predetermined value (e.g., point the opposite direction about their respective axes). For example, angle 531 for capsules 200a and 200c and angle 532 for 200b, and 200f may all be the same angle and point upward (e.g., in the +z direction), while angle 531 for capsules 200c and 200g and angle 532 for 200d, and 200h may all be the same and angled downward (e.g., in the +z direction, 180 degrees offset from capsules 200a, 200b, 200e, and-200f about their respective axes). As further shown in FIGS. 6a-6c, capsules 200a, 200b, 200c, and 200f point (e.g., the maximum sensitivity vectors point) in a direction away from the direction of rotation of the capsules about the central axis, and capsules 200c, 200d, 200g, and 200h point (e.g., the maximum sensitivity vectors point) in a direction towards the direction of rotation of the capsules about the central axis.

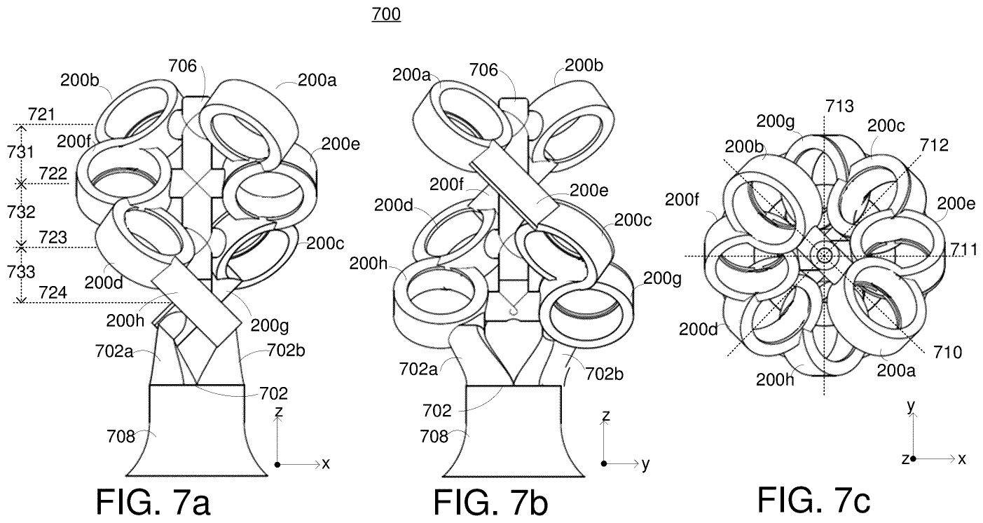

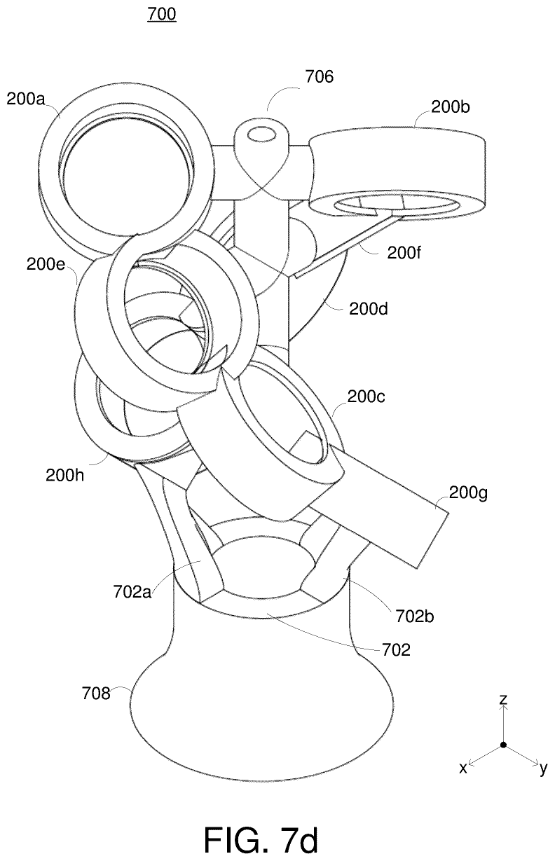

FIGS. 7a-7d illustrate various views of microphone 700 that may be used to implement one or more illustrative aspects described herein (e.g., microphone 100). For example, FIG. 7a illustrates a left view, FIG. 7b illustrates a front view, FIG. 7c illustrates a top view, and FIG. 7d illustrates a perspective view of microphone 700. Similar to FIGS. 5a-5d, FIGS. 7a-7d include references to a cartesian coordinate system having x, y, and z axes, which are included for the purpose of illustrating and describing the relative arrangement of elements to each other. These axes do not represent the absolute position of microphone 700 or its elements with respect to a surrounding environment in which the microphone might be positioned.

Microphone 700 may include microphone capsules 200a-200h, which may be the same as those described above with respect to FIGS. 5a-5g.

As illustrated in FIGS. 7a, 7b, and 7d, microphone 700 may include yoke 702. Yoke 702 may be constructed according to one or more shapes and/or geometries. Yoke 702 may include a support 706, which may be constructed according to one or more shapes or geometries (e.g., a columnar post). One or more of the microphone capsules 200a-200h may be coupled (e.g., by one or more cross-members or by coupling between capsules) to yoke 702 along support 706 (which may be the same or similar to protruding member 206 described above). One or more of the microphone capsules may be electrically connected to yoke 702 and/or support 706.

Support 706 may define a substantially central axis (e.g., z-axis, vertical axis) along which the microphone capsules may be disposed. The microphone capsules may be integrally molded to support 706 or detachably coupled to support 706. The microphone capsules may be rotatably and/or pivotably coupled to support 706 such that a user may variably rotate capsules about support 706 (e.g., about the central, z-axis) and/or pivot the direction of microphone capsules (e.g., along an axis parallel to the x-y plane) as further described with respect to FIGS. 7e-7d below.

Microphone 700 may include a neck 708, yoke 702 with one or more legs (e.g., 702a, 702b), and support 706, which include all of the features and have the same or similar functions as described above with respect to neck 508, yoke 502 with one or more legs (e.g., 502a, 502b), and support 506, respectively.

As shown in FIGS. 7a-7d, the microphone capsules may be arranged in four pairs, a first pair including 200a and 200b, a second pair including 200e and 200f, a third pair including 200c and 200d, and a fourth pair including 200g and 200h. Microphone capsules 200a-200d of the first and the third pairs may form a base set of microphone capsules, arranged the same as or similar to the set of microphone capsules 200a-200d, respectively, of microphone 200 as illustrated in FIGS. 2, 3a, 3b, and 4a-4d. Microphone capsules 200e-200h of the second and the fourth pairs may form a second base set of microphone capsules that are arranged the same as or similar to microphone capsules 200a-200d, but rotated 45 degrees (e.g., counterclockwise from the top view) about support 506 and lowered (moved in the negative central, z-axis direction) by a predetermined distance (e.g., by distances 731 and 733).

As shown in the top view in FIG. 7c, the first pair may be arranged along a first axis 710, the second pair may be arranged along a second axis 711, the third pair may be arranged along a third axis 712, and the fourth pair may be arranged along a fourth axis 713. In distinction to microphone 500, in microphone 700, each pair of microphone capsules may be positioned in different planes that are tangent to support 706 (perpendicular to the central, z-axis). For example, as shown in FIG. 7a, the first pair may be positioned in a first plane 721, the second pair may be positioned in a second plane 722, the third pair may be positioned in a third plane 723, and the fourth pair may be positioned in a fourth plane 724. The planes may be sequentially spaced, such that planes 721 and 722 may be separated by a distance 731, planes 722 and 723 may be separated by a distance 732, and planes 723 and 724 may be separated by a distance 733. Each of distances 731, 732, and 733 are configured to provide a temporal difference between the first, second, third, and/or fourth pairs in receiving sound originating in the z-axis or vertical direction. This enables microphone 700 to distinguish sound in the z-direction from sounds from other directions and determine whether the sound originates from a positive or negative z-axis or vertical direction.

As shown in the top view, in FIG. 7c, axes 710, 711, 712, and 713 may be at a different angle about the central axis (e.g., support 706). In some examples, each axis may be offset by the same angle with respect to the axis in the plane above it. For example, axis 711 (in plane 722) may be rotated around the central axis (e.g., support 706) by about 45 degrees (counter-clockwise) with respect to axis 710 (in plane 721), axis 712 (in plane 723) may be rotated around the central axis (e.g., support 706) by about 45 degrees (counter-clockwise) with respect to axis 711 (in plane 722), and axis 713 (in plane 724) may be rotated around the central axis (e.g., support 706) by about 45 degrees (counter-clockwise) with respect to axis 712 (in plane 723). While 45 degrees is used as an example, as illustrated in FIG. 7c, the angles may be rotated by other amounts, which may be the same or different for each axis. In some examples, microphone 700 is arranged in the same way as microphone 600, except that the axes in microphone 600 are rotated about support 606 in the opposite direction as the axes in microphone 700 about support 706.

In some embodiments, each pair of microphone capsules in microphone 700 (e.g., the first pair including 200a and 200b, the second pair including 200e and 200f, the third pair including 200c and 200d, and the fourth pair including 200g and 200h) may be arranged and have the same structure and function as microphone capsules 200-1 and 200-2 in FIGS. 5e-5g, respectively, as previously described, with axes 710-713 in FIGS. 7a-7c being the same as axis 560 in FIGS. 5e-5g.

In some examples, the maximum sensitivity vectors for the first pair of microphone capsules 200a and 200b may point towards opposite lateral directions perpendicular to axis 710, the maximum sensitivity vectors for the second pair of microphone capsules 200e and 200f may point towards opposite lateral directions perpendicular to axis 711, the maximum sensitivity vectors for the third pair of microphone capsules 200c and 200d may point towards opposite lateral directions perpendicular to axis 712, and the maximum sensitivity vectors for the fourth pair of microphone capsules 200g and 200h may point towards opposite lateral directions perpendicular to axis 713. Further, in some examples, the maximum sensitivity vectors for each of microphone modules 200a, 200b, 200c, and 200f point towards the positive z-direction (e.g., point upward, have angles 531 and 532 less than 90 degrees, and/or have positive z-values) and the maximum sensitivity vectors for each of microphone modules 200c, 200d, 200g, and 200h point towards the negative z-direction (e.g., point downward, have angles 531 and 532 greater than 90 degrees, and/or have negative-z-values) As shown in the top view of FIG. 7c, angle 531 for capsules 200a, 200c, 200c, and 200g and angle 532 for capsules 200b, 200f, 200d, and 200h may each have the same predetermined value, or be may be offset by 180 degrees from the predetermined value (e.g., point the opposite direction about their respective axes). For example, angle 531 for capsules 200a and 200c and angle 532 for 200b, and 200f may all be the same angle and point upward (e.g., in the +z direction), while angle 531 for capsules 200c and 200g and angle 532 for 200d, and 200h may all be the same and angled downward (e.g., in the −z direction, have an angle equal to 180 degrees plus the angle of 200a, 200b, 200e, and 200f about their respective axes). As further shown in FIGS. 7a-7c, capsules 200a, 200b, 200e, and 200f point (e.g., the maximum sensitivity vectors point) in a direction towards the direction of rotation of the capsules about the central axis, and capsules 200c, 200d, 200g, and 200h point (e.g., the maximum sensitivity vectors point) in a direction away from the direction of rotation of the capsules about the central axis.

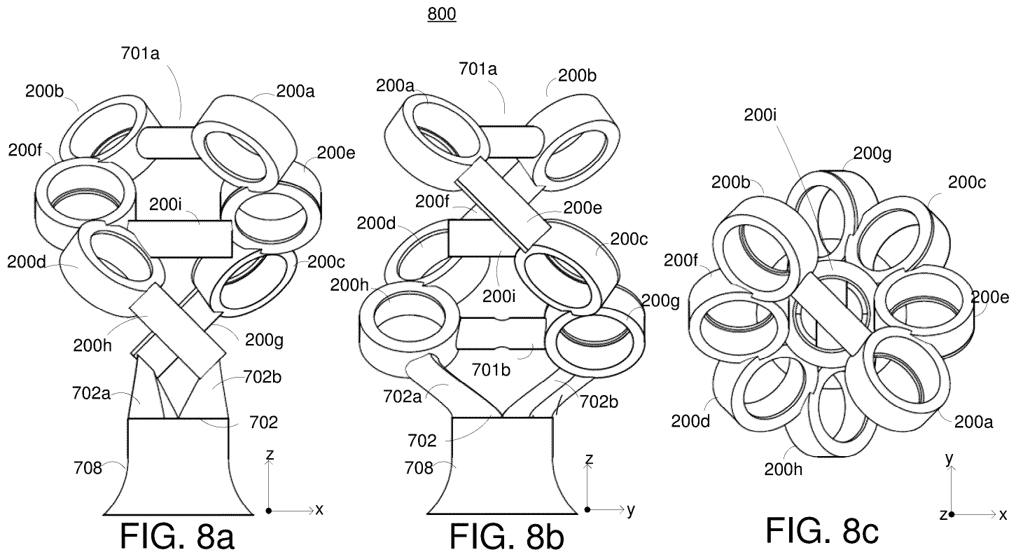

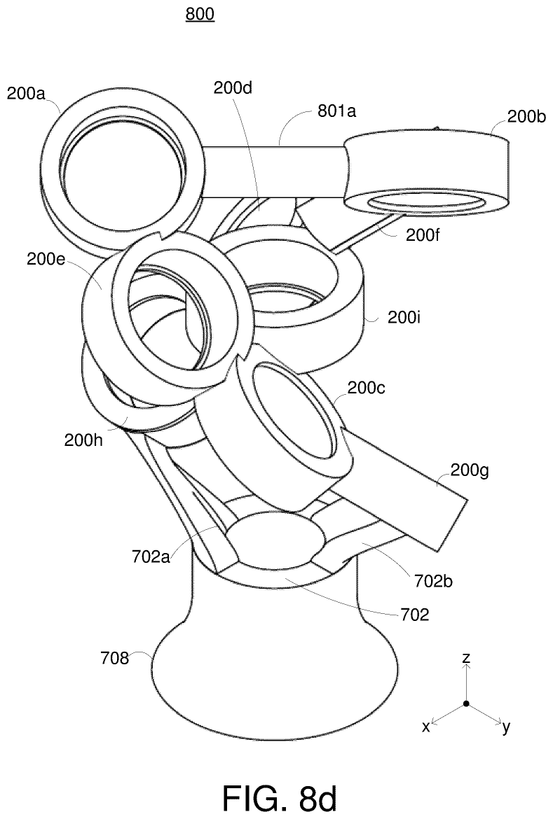

FIGS. 8a-8d illustrate various views of microphone 800 that may be used to implement one or more illustrative aspects described herein (e.g., microphone 100). For example, FIG. 8a illustrates a left view, FIG. 8b illustrates a front view, FIG. 8c illustrates a top view, and FIG. 8d illustrates a perspective view of microphone 800. Similar to FIGS. 5a-5d, FIGS. 8a-8d include references to a cartesian coordinate system having x, y, and z axes, which are included for the purpose of illustrating and describing the relative arrangement of elements to each other. These axes do not represent the absolute position of microphone 800 or its elements with respect to a surrounding environment in which the microphone might be positioned.

The elements, structure, and function of microphone 800 are the same as the elements, structure, and function of microphone 700 as described above, except that support 706 is replaced or supplemented with supports one or more supports 801 (e.g., 801a, 801b), and an additional microphone capsule 200i is added. In microphone 800, to couple the microphone capsules 200a-200h to yoke 702, each microphone capsule may be coupled to an adjacent capsule at a different height along the central axis (e.g., z-axis). For additional structural integrity, supports 801a, 801b, and/or other 801 may be included to couple any two or more of the capsules together.

Additional microphone capsule 200i may be nested in the middle of microphone capsules 200a-200h, and be oriented to point in the positive or negative z-direction. Microphone capsule 200i may be bidirectional and point in both the positive and negative z-direction.

Other examples of microphones, according to the concepts disclosed herein, include integrating an additional microphone capsule 200i into microphones 200, 500, and 600 in the z-direction and nested within (e.g., in the middle) of the other microphone capsules. In such examples, supports 206, 506, and 606 may be modified or eliminated, and additional supports 801 may be added to connect the microphone capsules together, and to the yoke.

As shown in the perspective views of microphones 500, 600, 700, and 800 in FIGS. 5d, 6d, 7d, and 8d, respectively, the microphone capsules may be geometrically arranged and compactly nested relative to one another such that the microphone capsules may exhibit a consistent and/or stable polar response at high frequencies. The microphone capsules may be compactly nested together to help minimize phase-related errors and/or to help provide higher spatial/localization accuracy. For example, in microphones 200, 500, 600, 700, and 800, the vertical distance (e.g. in the z-axis direction) may be reduced to less than the diameter of the microphone capsules because the capsules are all tilted about their respective axes, enabling the capsules to be nested in the vertical direction. Further the capsule tilt about their respective axes, and their rotation about the central axis (e.g., z-axis) reduces shading of each capsule by the other capsules. The microphone capsules may be geometrically oriented according to aspects described herein to reduce the acoustic shading due to structural interference introduced by one or more adjacent microphone capsules. That is, the geometric orientation of the microphone capsules may reduce acoustic shading by reducing the cross-section(s) of the obstruction caused by adjacent microphone capsules, which may help improve high frequency response.

FIG. 9 illustrates an example of a microphone system 900 that may be used to implement one or more illustrative aspects described herein, including one or more of microphones 100, 200, 500, 600, 700, 800, and/or any other microphone arrangement described herein that includes an array 920 of microphone capsules 200a-200n. Microphone system 900 may include and/or be communicatively connected to a processor 904 for controlling overall operation of the microphones. Microphone system 900may include an array 920 of microphone capsules 200a, 200b, 200c, 200d, and 200n. Microphone system 900may include and/or be communicatively connected to n-channel analog-to-digital (“A/D”) converter 902. In one or more examples, n may be greater than or equal to 2, 3, 4, 5, 6, 7, 8, or 9. The number of n microphone capsules may correspond to the number of n channels of A/D converter 902 (i.e., the number of microphone capsules and the number of channels in A/D converter 902, both represented as the integer n, may be the same). Microphone system 900 may include and/or be communicatively connected to memory 903. The memory 903 may store software (e.g., executed by processor 904), including operating system 906 for controlling overall operation of microphone system 900and/or control logic 907 for instructing microphone system 900 to perform aspects described herein. Functionality of the control logic 907 may refer to operations or decisions made automatically based on rules coded into the control logic 907, made manually by a user providing input into the system, and/or a combination of automatic processing based on user input (e.g., queries, data updates, user-selected modes, a list of input devices previously setup with the software application, etc.). Memory 903 may store data used in performance of one or more aspects described herein, including in at least one database 908. Memory may store other data. For example, where the memory 903 is part of, for example, microphone system 900, the memory may store its operating system and/or the software application that performs aspects described herein, user preferences such as preferred modes, a list of input devices (such as microphones 100, 200, 500, 600, 700, 800, and/or microphone capsules 200a-200n, among others) previously setup with the software application, communication protocol settings, and/or data supporting any other functionality of the microphones.

One or more aspects may be embodied in computer-usable or readable data and/or computer-executable instructions, such as in one or more program modules, executed by one or more computers (e.g., 102, 104, 904) or other devices as described herein, such as, for example, microphones 100, 200, 500, 600, 700, and/or 800. Generally, program modules include routines, programs, objects, components, data structures, etc. that perform particular tasks or implement particular abstract data types when executed by a processor in a computer or other device. The modules may be written in a source code programming language that is subsequently compiled for execution or may be written in a scripting language such as (but not limited to) Python, Perl, PHP, Ruby, JavaScript, and the like. The computer executable instructions may be stored on a computer readable medium such as a nonvolatile storage device. Any suitable computer readable storage media may be utilized, including hard disks, CD-ROMs, optical storage devices, magnetic storage devices, solid state storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware, and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

With further reference to FIGS. 1 through 9, the ambisonic microphone 200, 500, 600, 700, 800, and/or 900 may be implemented in device 100. The n-channel A/D converter 902, memory 203, processor 904, n-channel digital-to-audio (“D/A”) converter 911, and output port 912 may be implemented in microphone 100 and/or any one or more of devices 102, 104, and/or 106, as well as (or alternatively) in one or more additional devices (not shown). Aspects described herein may be operational with numerous other general purpose and/or special purpose computing system environments or configurations. Examples of other computing systems, environments, and/or configurations that may be suitable for use with aspects described herein include, but are not limited to, personal computers, server computers, hand-held or laptop devices, multiprocessor systems, microprocessor-based systems, set top boxes, programmable consumer electronics, network personal computers (PCs), minicomputers, mainframe computers, supercomputers configured to run online application programming interfaces (APIs), distributed computing environments that include any of the above systems or devices, and the like. Aspects of microphone (e.g., 200, 500, 600, 700, 800, and/or 900) may be implemented as embedded software running in, for example, device 100. Aspects of microphone (e.g., 200, 500, 600, 700, 800, and/or 900) may be implemented as an external signal processor, such as a hardware DSP module, a real-time software processor, an offline software processor, or a software plug-in (including VST, AU, and AAX formats). The ambisonic microphone (e.g., 200, 500, 600, 700, 800, and/or 900) may be compatible with software or plugins for use with any number of video communications or video streaming platforms.

Microphone capsules 200a-200n may be configured to receive acoustic signals emanating from various directions in an acoustic environment. The microphone capsules may capture a set of audio signals in A-format. The set of audio signals may vary widely in duration (e.g. from less than one second to more than 1000 seconds). The microphone capsules may provide the set of A-format audio signals to an external device (e.g., 102, 104, 901, 902, 904). Onboard processing (e.g., system 900, processor 904) of the ambisonic microphone may encode the set of A-format audio signals to B-format, C-format (or Ambisonic UHJ, such as nested multi-channel output formats), D-format (such as 3.1, 5.1, 5.1.n 7.1, 7.1.n and/or other surround sound formats, including custom speaker array formats and other formats with pre-encoded channels), G-format, mono, stereo, and/or to a binaural audio format for headphone listening (described further below with respect to FIG. 9). Processor 904 may render the A-format, B-format, C-format, D-format, and/or G-format audio signals for use in an external device. Microphone 200 may provide the rendered set of mono, stereo, binaural, B-format, C-Format, D-format, and/or G-format audio signals to an external device.

As shown in FIG. 9, ambisonic microphone system 900may include a converter module 930 and/or be communicatively connected to the converter module 930. Converter module 930 may include a device controller 901. The device controller 901 may facilitate interaction from microphone capsules 200a-200n to various components of converter module 930. Analog and/or digital audio may be transmitted from microphone array 920 to the device controller 901. Digital data may be transmitted bidirectionally (from the microphone array 920 to the device controller 901, and/or from the device controller 901 to microphone array 920). Microphone array 920 may include, for example, one or more universal serial bus (USB) connectors, one or more XLR connectors, one or more power connectors, and/or any other type of data and/or power connectors suitable for transporting signals such as power, digital data (including digital audio signals), and/or analog audio signals to and from the microphone array 920. Where the connection is wired, the device controller 901 may further comprise a data interface (not shown) for communicating with microphone array 920. For example, the data interface may comprise a USB interface and/or an XLR interface. While several wired connections are discussed between the device controller 901 and the microphone array 920, other types of wired or wireless connections may be used. For example, the connection between the device controller 901 and microphone array 920 may instead be a wireless connection, such as a Wi-Fi connection or other proprietary wireless connection protocols, a Bluetooth connection, a near-field connection (NFC), and/or an infrared connection. Where the connection is wireless, the device controller 901 and microphone array 920 may include a wireless communications interface.

In operation, device controller 901 may receive a set of A-format audio signals captured with microphone capsules 200a-200n. Device controller 901 may route the set of A-format audio signals to A/D converter 902, which may provide a set of digital A-format audio signals to processor 904 for further processing. Processor 904 may provide the set of digital set of A-format audio signals to D/A converter 911 for output via output port 912 to an output device 914. The number of n channels of D/A converter 911 may correspond to the number of n channels of A/D converter and/or to the number of n microphone capsules (i.e., the number of channels in D/A converter 911, represented as the integer n, may be the same as the number of channels in A/D converter 902 and/or same as the number of microphone capsules). Output device 914 may be any of devices 102, 104, and/or other devices such as a mixing console, recording console, headphones, earphones, etc.

Converter module 930 may include an encoder/decoder 910. Encoder 910 may be configured to encode (or convert) the set of digital A-format audio signals to a set of B-format audio signals. Encode 910 may be configured to decode (or render) the set of B-format audio signals to D/A converter 911 and via port 912 for use in output device 914. As has been discussed, the orientation and arrangement of microphone capsules 200a-200d according to aspects described herein may minimize A-format to B-format conversion errors and localization inaccuracies that might typically result from the non-coincidence of the microphone capsules in an ambisonic microphone. As a result, the B-format stability (or bi-directional collapse point) of the microphone capsules may be improved at higher frequencies. That is to say that the beamformed patterns and frequency response patterns of the microphone capsules may remain stable while capturing audio signals with frequencies occupying ranges from about 20-20 kHz. Encoder 910 may employ any number of time-domain processing techniques when performing A-format to B-format encoding of the set of audio signals. Encoder 910 and/or processor 904 may employ any number of purely time-domain processing techniques when performing A-format to B-format encoding of the set of audio signals. That is, encoder 910 and/or processor 904 might not perform Fast Fourier Transformation of the set of A-format audio signals before encoding to B-format. Rather, encoder 910 and/or processor 904 may analyze one or more waveforms of the set of audio signals. Encoder 910 and/or processor 904 might not convert the set of audio signals into spectral components and might not analyze those spectral components of the set of audio signals. In one or more examples, frequency response correction filters, equalization filters, and/or other corrective measures might be unnecessary. In one example, e.g., for the microphone 200 illustrated in FIGS. 2-4d, encoder 910 and/or processor 904 may encode the set of A-format audio signals to first order B-format audio signals by employing the convention:

$$W = F L U + F R D + B L D + B R U \\ X = F L U + F R D - B L D - B R U \\ Y = F L U - F R D + B L D - B R U \\ Z = F L U - F R D - B L D + B R U$$

where W represents an omnidirectional microphone channel and X, Y, and Z represent bi-directional (or figure-of-eight) microphone channels; and where FLU (front left up) may represent the signal captured by microphone capsule 200a, BRU (back right down) may represent the signal captured by microphone capsule 200b, BLD (back left down) may represent the signal captured by microphone capsule 200c, and FRD (front right down) may represent the signal captured by microphone capsule 200d. The W-channel may be attenuated by about 3 dB (i.e., by a factor of \sqrt{2} or 0.707). As a result of employing time-domain processing, processing latency may be reduced and microphone 200 may provide real-time A-format or decoded B-format audio signals for latency-critical applications such as livestreaming, etc. Encoder/decoder 910 may support any number of B-Format export formats, including, for example, FuMa, Ambix, and the like.

In other examples, e.g., for the microphones 500, 600, 700, and 800, first-order B-format audio signals may be generated by secondary processing of two sets of first-order B-format audio signals: a first set of B-format audio signals generated from a first base set of audio data from a first base set of microphone capsules (e.g., 200a-200d), and a second set of B-format audio signals generated from a second base set of audio data from a second base set of microphone capsules (e.g., 200c-200h). To encode a first set of first-order B-format audio signals, the above matrix operation may be applied to the first base set of microphone capsules 200a-200d as described above. To encode a second set of B-format audio signals, the above matrix operation may be applied to the second base set of microphone capsules 200e-200h as described above.

The examples described with respect to microphones 500, 600, 700, and 800 provide several benefits over prior designs. For example, because the microphone capsules are nested in each of microphones 200, 500, 600, 700, and 800, the phase error is reduced due to the closer proximity of the capsules, while shading between the capsules is also minimized, which improves accuracy of audio signal reception. Further, the examples presented with respect to microphone 500, 600, 700, and 800 allow for better directionality and better accuracy across a wider frequency band and accuracy due to the addition of a second base set of microphone capsules nested with the first base set in a precise way. The addition of the second base set of microphone capsules enables more accurate generation of second-order B-format signals (e.g., V, T, R, S, and U signals). In particular, the examples presented with respect to microphone 600, 700, and 800, introduce four functional planes in the z-axis direction, which enables additional phase and time offset detection (e.g., between the first and second base sets of microphone capsules), which in turn enables more accurate directional detection in the z-direction. Still further, the addition of a ninth capsule (e.g., 200i) in the examples presented with respect to microphone 800 (or added to any of the other microphones) enables accurate measurement and correction of errors in the z axis direction (e.g., in the determination of the second-order R signal, which has a bidirectional sensitivity pattern pointed in the z-axis direction).

Encoder/decoder 910 may be configured to decode the set of B-format audio signals to a set of D-format audio signals. Converter module 930 may include an interface controller 905 communicatively connected to a user interface 915. The interface controller 905 may facilitate communication between a user interface 915 and the converter module 930. For example, the interface controller 905 may receive user indications and/or queries from user interface 915 and provide the indications and/or queries to the converter module for further actions described herein. The user interface 915 may comprise, for example, a capacitive-touch interface that a user may control via touch, or a graphical user interface. A companion software application (not shown) installed on the device 102 and/or device 104 may provide the user interface 915 and may perform some or all of the processing and decoding of the audio signals described herein.

The interface 915 may function in concert with some or all of the hardware and/or software components described herein to help simplify the setup and workflow of capturing spatial audio with microphone array 920 and providing it to a consumer. The user interface 915 may present a user with several audio capture and conversion options. For example, interface 915 may provide the user with options to output captured audio signals in mono, stereo, binaural, A-format, B-format, C-format, D-format, and/or G-format audio standards to an external device. Interface 915 may provide the user with other pre- and/or post-recording processing options, such as filtering, equalization, compression, and steerable virtual microphones with independent position/localization and gain adjustments, etc. Interface 915 may provide the user with a graphical representation of an acoustic sound field and may allow the user to create any number of virtual microphones and manipulate the polarity of said virtual microphones. Interface 915 may include a video feed window to allow a user to monitor the synchronization of incoming audio signals to either live or pre-recorded video data.

Any of the circuitry in FIG. 9 may be implemented, for example, as a programmable gate array (PGA), as a MOS integrated circuit (IC) chip, an application specific integrated circuit (ASIC), a complex programmable logic device (CPLD) a field-programmable gate array (FPGA) chip, or an analog electrical circuit. The ASIC could contain a transistor, such as a FET. Any of the operations described herein may be implemented with hardware, software, and/or a combination thereof.

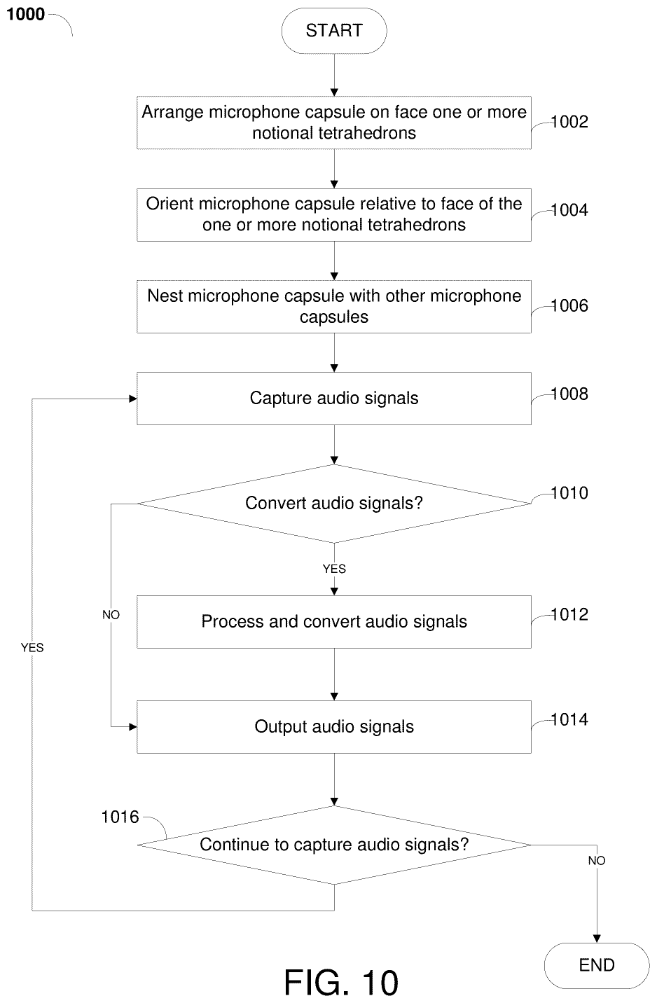

FIG. 10 illustrates an example flowchart of method 1000 that may be performed to implement one or more illustrative aspects described herein. Some or all of the steps of method 1000 may be performed by microphone 100, 200, 500, 600, 700, 800, 900, and/or any other microphone described herein. Some or all of the steps of method 1000 may be performed by a device connected to the microphone (such as devices 102 and/or 104). Processor 904 coupled to memory 903 may control the overall operation of the microphone as it performs steps 1001-1016. While method 1000 shows particular steps in a particular order, the method may be further subdivided into additional sub-steps, steps may be combined, the steps may be performed in other orders, and some steps may be omitted without necessarily deviating from the concepts described herein.

In operation, one or more microphone capsules may be arranged or oriented in a first direction relative to one or more notional tetrahedron according to aspects described herein. For example, a first microphone capsule may be arranged on a first face of notional tetrahedron in a direction substantially toward a first vertex of the notional tetrahedron (Step 1002). The face of the microphone capsule may be oriented relative to (or with respect to) the face of the notional tetrahedron (e.g., orthogonally, substantially orthogonally, parallel, substantially parallel) (Step 1004). The first microphone capsule may be oriented relative to a second microphone capsule such that the axis of minimum sensitivity of the first capsule may share a coincident point with the axis of minimum sensitivity of the second capsule (e.g., the axes may intersect at a point in space). The axes of maximum sensitivity of the first and second microphone capsules might not share a coincident point with one another. The third and fourth microphone capsules may be oriented relative to one another such that the axis of minimum sensitivity of the third capsule may share a coincident point with the axis of minimum sensitivity of the fourth capsule (i.e., the axes may intersect at a point in space). The first, second, third, and/or fourth microphone capsules may be oriented with respect to one another to reduce structural interference and acoustic shading associated that may be caused by adjacent microphone capsules. The one or more notional tetrahedrons may be oriented with respect to each other by rotation about a vertical axis by a predetermined angle, such as 45 or 90 degrees.

The first microphone capsule may be nested with one or more other microphone capsules in accordance with aspects described herein to help reduce phase-related errors (e.g, as in microphones 200, 500, 600, 700, and/or 800). (Step 1006). The microphone capsules may be configured to capture audio signals (Step 1008). The user may wish to convert the set of captured audio signals (e.g., A-format audio signals) to any number of different audio standards (e.g., B-format, C-format, D-format, G-format, mono, stereo, binaural, etc.). The user may indicate, via an interface (such as interface 915) and/or the microphone, that the user wishes for such conversion to occur and may specify the desired format. Based on receiving a conversion indication (Step 1010: YES), the system 900 may employ time-domain processing techniques as described herein to convert the A-format audio signals to the desired format (Step 1012) for further processing and/or output to, for example, output device 914 (Step 1014). In one or more examples, the output audio signals may be synced to a video feed, including a livestream, broadcast, etc. The user may wish to output the raw A-format audio signals to an external device. Based on receiving an indication to output the raw A-format audio signals (Step 1010: NO), the system 900 may provide the A-format audio signals to output port 912 for conversion and/or further processing by, for example, output device 914 (Step 1014). The microphone capsules may automatically continue to capture audio signals indefinitely (Step 1016: YES). System 900 may receive an indication to stop capturing audio signals (Step 1016: NO), upon which method 1000 may terminate.

The aspects described herein may be performed by a number of device configurations. For example, a user may connect, for example, microphones 100, 200, 500, 600, 700, 800 and/or any other microphone described herein to devices 102, 104, and/or other devices operating a software application capable of performing the operations described herein. In another example, the aspects described herein can be performed by a smartphone, desktop computer, laptop computer, and/or other devices having an internal microphone and a software application capable of performing the operations described herein. No other audio equipment might be necessary to perform the operations described herein.

An ambisonic microphone may comprise a plurality of microphone capsules. The plurality of microphone capsules may be geometrically arranged to reduce an acoustic shading effect from a structural interference. The plurality of microphone capsules may be compactly nested to reduce a phase related error.

In some examples, an ambisonic microphone may comprise a central axis and first, second, third, and fourth pairs of microphone capsules. In some variations, each of the first, the second, the third, and the fourth pairs may comprise an alignment axis perpendicular to the central axis. In some variations, the first and second microphone capsules may have first and second maximum sensitivity vectors, respectively, that are perpendicular to the alignment axis and offset in opposite directions from the central axis by a first distance. In some variations, the alignment axes of the first and the second pairs may be spaced apart along the central axis by a second distance, and the alignment axes of the third and the fourth pairs may be spaced apart along the central axis by the second distance.

In some examples, the alignment axes for the first, the second, the third, and the fourth pairs define first, second, third, and fourth planes, respectively, that intersect along the central axis, wherein the first plane is perpendicular to the second plane and the third plane is perpendicular to the fourth plane.

In some examples, for each of the first, the second, the third, and the fourth pairs, the first and the second maximum sensitivity vectors are pivoted about the alignment axis at a common angle and in opposite directions with respect to a plane formed by the alignment axis and the central axis. In some variations, the common angle of the first pair and the common angle of the third pair may equal a first value, and the common angle of the second pair and the common angle of the fourth pair may equal 180 degrees plus the first value. In some variations, the common angle of the first pair and the common angle of the third pair may be between 30 and 60 degrees, and the common angle of the second pair and the common angle of the fourth pair may be between 150 and 240 degrees.

In some examples of the ambisonic microphone, for each of the first, the second, the third, and the fourth pairs, the first and the second microphone capsules may have a common diameter, and the second distance may be less than the diameter

Some examples of the ambisonic microphone may comprise one or more integrated circuits configured to convert a first base set of audio signals from the first and the second pairs to a first set of B-format audio signals, and convert a second base set of audio signals from the third and the fourth pairs to a second set of B-format audio signals.

In some variations of the ambisonic microphone, the alignment axes of the first and the third pairs are in a first plane perpendicular to the central axis, and the alignment axes of the second and the fourth pairs are in a second plane perpendicular to the central axis. In some variations, the alignment axes of the first and the third pairs may be rotated 45 degrees about the central axis with respect to each other, and the alignment axes of the second and the fourth pairs may be rotated 45 degrees about the central axis with respect to each other.

In some examples of the ambisonic microphone, the alignment axes of the first, the third, the second, and the fourth pairs are sequentially spaced along the central axis, and the alignment axes of the third, the second, and the fourth pairs are rotated about the central axis in a common angular direction by a predetermined angle relative to the alignment axes of the first, the third, and the second pairs, respectively. In some variations, the predetermined angle may be about 45 degrees. In some variations, for each of the first and the third pairs, the first and the second maximum sensitivity vectors may be pivoted about the alignment axis away from the common angular direction, and for each of the second and the fourth pairs, the first and the second maximum sensitivity vectors may be pivoted about the alignment axis towards the common angular direction. In some variations, for each of the first and the third pairs, the first and the second maximum sensitivity vectors may be pivoted about the alignment axis towards the common angular direction, and for each of the second and the fourth pairs, the first and the second maximum sensitivity vectors may be pivoted about the alignment axis away from the common angular direction.

In some examples, the ambisonic microphone may comprise a bidirectional microphone capsule having a maximum sensitivity vector aligned with or parallel to the central axis. In some variations, the bidirectional microphone capsule is nested between the third and the second microphone capsules along the central axis.

Other examples may include an ambisonic microphone comprising a central axis; and multiple sets of microphone capsules. Each set of the multiple sets may comprise first and second microphone capsules positioned along a first axis that is perpendicular to the central axis, and third and fourth microphone capsules positioned along a second axis that is perpendicular to the central axis, spaced apart from the first axis by a predetermined distance along the central axis, and rotated about the central axis by 45 degrees with respect to the first axis. The multiple sets may be arranged in a sequence such that, after a first set in the sequence, each set of the multiple sets is rotated about the central axis in a common angular direction by a predetermined angle with respect a prior set in the sequence. Some variations, may comprise a bidirectional microphone capsule having a maximum sensitivity vector aligned with or parallel to the central axis.

In some variations, for each set of the multiple sets of microphones: the first, the second, the third, and the forth microphone capsules are geometrically arranged on a notional tetrahedron that has first, second, third, and fourth faces, and first, second, third, and fourth vertexes; a center of the first microphone capsule intersects a centroid of the first face and is oriented towards the first vertex; a center of the second microphone capsule intersects a centroid of the second face and is oriented towards the second vertex; a center of the third microphone capsule intersects a centroid of the third face and is oriented towards the third vertex; and a center of the fourth microphone capsule intersects a centroid of the fourth face and is oriented towards the fourth vertex.

In some variations of the ambisonic microphone, for each set of the multiple sets of microphones, a maximum sensitivity vector of each of the first and the second microphone capsules may be pivoted about the first axis towards the common angular direction, and a maximum sensitivity vector of each of the third and the fourth microphone capsules may be pivoted about the second axis away from the common angular direction.

In some variations, of the ambisonic microphone, for each set of the multiple sets of microphones, a maximum sensitivity vector of each of the first and the second microphone capsules may be pivoted about the first axis away from the common angular direction, and a maximum sensitivity vector of each of the third and the fourth microphone capsules may be pivoted about the second axis towards the common angular direction.

In the foregoing specification, the present disclosure has been described with reference to specific exemplary examples thereof. Although the invention has been described in terms of a preferred example, those skilled in the art will recognize that various modifications, examples or variations of the invention can be practiced within the spirit and scope of the invention as set forth in the appended claims. The specification and drawings are, therefore, to be regarded in an illustrated rather than restrictive sense. Accordingly, it is not intended that the invention be limited except as may be necessary in view of the appended claims.

What is claimed is:

1. An ambisonic microphone comprising:
a central axis; and
first, second, third, and fourth pairs of microphone capsules, wherein each of the first, the second, the third, and the fourth pairs comprises:
an alignment axis perpendicular to the central axis; and
first and second microphone capsules having first and second maximum sensitivity vectors, respectively, that are perpendicular to the alignment axis and offset in opposite directions from the central axis by a first distance;
wherein the alignment axes of the first and the second pairs are spaced apart along the central axis by a second distance; and
wherein the alignment axes of the third and the fourth pairs are spaced apart along the central axis by the second distance.

2. The ambisonic microphone of claim 1, wherein:
the alignment axes for the first, the second, the third, and the fourth pairs define first, second, third, and fourth planes, respectively, that intersect along the central axis;
the first plane is perpendicular to the second plane; and
the third plane is perpendicular to the fourth plane.

3. The ambisonic microphone of claim 1, wherein, for each of the first, the second, the third, and the fourth pairs, the first and the second maximum sensitivity vectors are pivoted about the alignment axis at a common angle and in opposite directions with respect to a plane formed by the alignment axis and the central axis.

4. The ambisonic microphone of claim 3, wherein the common angle of the first pair and the common angle of the third pair equal a first value, and the common angle of the second pair and the common angle of the fourth pair equal 180 degrees plus the first value.

5. The ambisonic microphone of claim 3, wherein the common angle of the first pair and the common angle of the third pair are between 30 and 60 degrees, and the common angle of the second pair and the common angle of the fourth pair are between 150 and 240 degrees.

6. The ambisonic microphone of claim 3, wherein, for each of the first, the second, the third, and the fourth pairs, the first and the second microphone capsules have a common diameter, and wherein in the second distance is less than the common diameter

7. The ambisonic microphone of claim 1, further comprising one or more integrated circuits configured to:
convert a first base set of audio signals from the first and the second pairs to a first set of B-format audio signals; and
convert a second base set of audio signals from the third and the fourth pairs to a second set of B-format audio signals.

8. The ambisonic microphone of claim 1, wherein:
the alignment axes of the first and the third pairs are in a first plane perpendicular to the central axis; and
the alignment axes of the second and the fourth pairs are in a second plane perpendicular to the central axis.

9. The ambisonic microphone of claim 8, wherein:
the alignment axes of the first and the third pairs are rotated 45 degrees about the central axis with respect to each other; and
the alignment axes of the second and the fourth pairs are rotated 45 degrees about the central axis with respect to each other.

10. The ambisonic microphone of claim 1, wherein the alignment axes of the first, the third, the second, and the fourth pairs are sequentially spaced along the central axis, and the alignment axes of the third, the second, and the fourth pairs are rotated about the central axis in a common angular direction by a predetermined angle relative to the alignment axes of the first, the third, and the second pairs, respectively.

11. The ambisonic microphone of claim 10, wherein the predetermined angle is about 45 degrees.

12. The ambisonic microphone of claim 10, wherein:
for each of the first and the third pairs, the first and the second maximum sensitivity vectors are pivoted about the alignment axis away from the common angular direction; and
for each of the second and the fourth pairs, the first and the second maximum sensitivity vectors are pivoted about the alignment axis towards the common angular direction.

13. The ambisonic microphone of claim 10, wherein:
for each of the first and the third pairs, the first and the second maximum sensitivity vectors are pivoted about the alignment axis towards the common angular direction; and
for each of the second and the fourth pairs, the first and the second maximum sensitivity vectors are pivoted about the alignment axis away from the common angular direction.

14. The ambisonic microphone of claim 10, further comprising a bidirectional microphone capsule having a maximum sensitivity vector aligned with or parallel to the central axis.

15. The ambisonic microphone of claim 14, wherein the bidirectional microphone capsule is nested between the third and the second microphone capsules along the central axis.

16. An ambisonic microphone, comprising:
a central axis; and
multiple sets of microphone capsules, wherein each set of the multiple sets comprises:
first and second microphone capsules positioned along a first axis that is perpendicular to the central axis; and
third and fourth microphone capsules positioned along a second axis that is perpendicular to the central axis, spaced apart from the first axis by a predetermined distance along the central axis, and rotated about the central axis by 45 degrees with respect to the first axis; and
wherein the multiple sets are arranged in a sequence such that, after a first set in the sequence, each set of the multiple sets is rotated about the central axis in a common angular direction by a predetermined angle with respect a prior set in the sequence.

17. The ambisonic microphone of claim 16, wherein, for each set of the multiple sets of microphones:
the first, the second, the third, and the forth microphone capsules are geometrically arranged on a notional tetrahedron that has first, second, third, and fourth faces, and first, second, third, and fourth vertexes;
a center of the first microphone capsule intersects a centroid of the first face and is oriented towards the first vertex;
a center of the second microphone capsule intersects a centroid of the second face and is oriented towards the second vertex;
a center of the third microphone capsule intersects a centroid of the third face and is oriented towards the third vertex; and
a center of the fourth microphone capsule intersects a centroid of the fourth face and is oriented towards the fourth vertex.

18. The ambisonic microphone of claim 16, further comprising a bidirectional microphone capsule having a maximum sensitivity vector aligned with or parallel to the central axis.

19. The ambisonic microphone of claim 16, wherein, for each set of the multiple sets of microphones:
a maximum sensitivity vector of each of the first and the second microphone capsules are pivoted about the first axis towards the common angular direction; and
a maximum sensitivity vector of each of the third and the fourth microphone capsules are pivoted about the second axis away from the common angular direction.

20. The ambisonic microphone of claim 16, wherein, for each set of the multiple sets of microphones:
a maximum sensitivity vector of each of the first and the second microphone capsules are pivoted about the first axis away from the common angular direction; and
a maximum sensitivity vector of each of the third and the fourth microphone capsules are pivoted about the second axis towards the common angular direction.
